(19) United States
(12) Patent Application Publication
(10) Pub. No.: US 2026/0223844 A1
(43) Pub. Date: Aug. 6, 2026

(54) METHODS AND COMPOSITIONS FOR ALTERING METABOLITES IN HOP PLANTS

(71) Applicant: Impello Biosciences, Inc., Fort Collins, CO (US)

(72) Inventors: Michael C. KEY, Fort Collins, CO (US); Michael J. DILEGGE, Longmont, CO (US); Hunter C. KONCHAN, Fort Collins, CO (US)

(21) Appl. No.: 19/151,402

(22) PCT Filed: Feb. 2, 2024
(86) PCT No.: PCT/US2024/014285

§ 371 Date: Jul. 28, 2025

Related U.S. Application Data
(60) Provisional application No. 63/442,998, filed on Feb. 2, 2023.

(51) Int. Cl. A01N 37/42; A01N 25/30; A01N 27/00; A01N 37/10; A01P 21/00

(52) U.S. Cl. CPC A01N 37/42; A01N 25/30; A01N 27/00; A01N 37/10; A01P 21/00

(57) ABSTRACT

The disclosure relates to methods and compositions for altering the production of one or more plant metabolites comprising applying an effective amount of at least one elicitor, wherein the elicitor is a jasmonate or a salicylate, and combinations thereof. The disclosure further teaches compositions comprising effective amounts of the elicitors disclosed here.

### CROSS-REFERENCE TO RELATED APPLICATIONS

This application claims the benefit of U.S. Provisional Application No. 63/442,998 filed on Feb. 2, 2023, the contents of which are herein incorporated by reference in their entirety.

### FIELD OF THE DISCLOSURE

The disclosure relates to biochemical compounds for improving plant productivity and/or harvestable crop value and methods of application.

### BACKGROUND

Much advancement has been made with respect to plant genetics. Hop varieties are being improved by using molecular markers for desirable traits, and transformation and genetic engineering for disease tolerance. However, these methods take time. It can take 20 years to develop a new hop cultivar by traditional breeding techniques, and once planted, three years or more to produce a crop of hops. Thus, there remains a need for compositions and methods to improve the qualities of existing hop cultivars.

### BRIEF SUMMARY

The disclosure teaches a method for altering the production of one or more metabolites in a hop plant, plant part, or plant cell, comprising: applying an effective amount of at least one elicitor, wherein the at least one elicitor is a jasmonate selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.

The disclosure further teaches a method of altering metabolite levels in a hop plant, plant part, or plant cell, said method comprising: applying an effective amount of methyl dihydrojasmonate to a hop plant or plant part.

The disclosure further teaches a method for increasing the content of a bitter acid in a hop plant, plant part, or plant cell, the method comprising: applying an effective amount of methyl dihydrojasmonate, wherein said effective amount is comprised of a composition having between 0.1 mM and 10 mM methyl dihydrojasmonate applied at an application rate of between 10-150 gallons per acre.

The disclosure further teaches a method for increasing the content of a terpene in a hop plant, plant part, or plant cell, the method comprising: applying an effective amount of methyl dihydrojasmonate, wherein said effective amount is comprised of a composition having between 0.1 mM and 10 mM methyl dihydrojasmonate applied at an application rate of between 10-150 gallons per acre.

The disclosure further provides a composition comprising methyl dihydrojasmonate and plant tissue from a hop plant.

### BRIEF DESCRIPTION OF THE SEVERAL VIEWS OF THE DRAWINGS

The accompanying figures, which are incorporated herein and form a part of the specification, illustrate some, but not the only or exclusive, example embodiments and/or features. It is intended that the embodiments and figures disclosed herein are to be considered illustrative rather than limiting.

FIG. 1A-1C show the results of a terpene analysis of hop plants treated with methyl dihydrojasmonate (MDJ), methyl salicylate (MS), or a combination thereof. FIG. 1A shows results for terpene peak height; FIG. 1B shows results for terpene peak area; and FIG. 1C shows results for percent terpenes.

FIG. 2 shows results for total oil content in % w/w, comparing control hop plants (“CK2”) to hop plants treated with 1 mM MDJ (“TR1”) or 5 mM MDJ (“TR2”).

FIG. 3A-3D show results of a bitter acids analysis, comparing control hop plants (“CK2”) to hop plants treated with 1 mM MDJ (“TR1”) or 5 mM MDJ (“TR2”). FIG. 3A shows results for beta acid content; FIG. 3B shows results for colupulone; FIG. 3C shows results for alpha acid content; and FIG. 3D shows results for cohumulone.

FIG. 4A-4Z show results of a terpene analysis, comparing control hop plants (“CK2”) to hop plants treated with 1 mM MDJ (“TR1”) or 5 mM MDJ (“TR2”). FIG. 4A shows results for 2-undecanone; FIG. 4B shows results for α-pinene; FIG. 4C shows results for β-ionone; FIG. 4D shows results for β-pinene; FIG. 4E shows results for caryophyllene; FIG. 4F shows results for caryophyllene oxide; FIG. 4G shows results for citral; FIG. 4H shows results for citronellene; FIG. 4I shows results for farnesene; FIG. 4J shows results for geraniol; FIG. 4K shows results for geranyl acetate 1; FIG. 4L shows results for geranyl acetate 2; FIG. 4M shows results for humulene; FIG. 4N shows results for limonene; FIG. 4O shows results for linalool; FIG. 4P shows results for methyl laurate; and FIG. 4Q shows results for methyl octanoate; FIG. 4R shows results for methyl thiohexanoate; FIG. 4S shows results for methyl heptanoate; FIG. 4T shows results for myrcene; and FIG. 4U shows results for nerol; FIG. 4V shows results for nerolidol 1; FIG. 4W shows results for nerolidol 2; FIG. 4X shows results for ocimene; FIG. 4Y shows results for terpinolene; and FIG. 4Z shows results for unidentified terpenes. FIG. 5A-5C show results of a thiol analysis, comparing control hop plants (“CK2”) to hop plants treated with 1 mM MDJ (“TR1”) or 5 mM MDJ (“TR2”). FIG. 5A shows results for 4MMP; FIG. 5B shows results for methyl thiohexanoate; and FIG. 5C shows results for unidentified thiols.

FIG. 6 is a bar graph showing the results of various treatments on hemp plants infected with Botrytis cinerea compared to an untreated control. Plants were scored on a scale of 0-5 and averaged, with 0 indicating no signs of infection.

FIG. 7A-7F show the results of bitter acids and terpene analysis of treated hop plants, comparing hop plants treated with 1 mM, 5 mM, or 10 mM MDJ. FIG. 7A shows results for total oil production in mL per 100 g; FIG. 7B shows results for alpha and beta acid content; FIG. 7C shows results for cobumulone; FIG. 7D shows results for colupolone; FIG. 7E shows results for terpene content; FIG. 7F shows results for additional terpene content.

FIG. 8 shows illustrative polyphenols of the disclosure.

### DETAILED DESCRIPTION

All publications, patents and patent applications, including any drawings and appendices, are herein incorporated by reference to the same extent as if each individual publication or patent application was specifically and individually indicated to be incorporated by reference.

The following description includes information that may be useful in understanding the present disclosure. It is not an admission that any of the information provided herein is prior art or relevant to the presently claimed disclosures, or that any publication specifically or implicitly referenced is prior art.

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present, unless the context clearly requires that there is one and only one of the elements.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 10% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

As used herein, the term “elicitor” refers to any molecule that stimulates a response in a plant. Elicitors may be exogenous or endogenous, and may for example, activate the production of a secondary metabolite.

As used herein, the term “jasmonate” or “jasmonates” refers to a class of compounds modulating plant responses to abiotic and biotic stimuli. The compounds may be produced endogenously in a plant, exogenously applied to a plant, or of synthetic origin, and include ethyl jasmonate, jasmonic acid, methyl dibydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

As used herein, “plant beneficial microbe(s)” refers to microorganisms that create symbiotic associations with plant roots, promote nutrient mineralization and availability, produce plant growth hormones, and/or are antagonists of plant pests, parasites or diseases.

As used herein, a “biostimulant” refers to a substance or micro-organism that, when applied to seeds, plants, or the rhizosphere, stimulates natural processes within the plant or the plant microbiome (including the entirety of the phytomicrombiome, e.g. the phyllosphere and rhizosphere) to enhance or benefit nutrient uptake, nutrient efficiency, tolerance to abiotic stress, or crop quality and yield.

As used herein, a “biological” or “agricultural biological” refers to a category of products derived from naturally occurring microorganisms, plant extracts, or other organic matter. In some embodiments, the biological is created from and/or contains living organisms, beneficial insects, plant extracts, or other organic matter.

As used herein, “altering” or “altered” may refer to an increase or decrease relative to a control value.

As used herein, “plant beneficial microbe(s)” refers to microorganisms that create symbiotic associations with plant roots, promote nutrient mineralization and availability, produce plant growth hormones, and are antagonists of plant pests, parasites or diseases.

As used herein, unless otherwise stipulated, percent content of a component is given as a weight percentage, i.e., “wt/wt” or “w/w”, calculated by dividing the weight of the component by the overall weight of the composition comprising the component.

### Overview

The disclosure relates to methods and compositions for altering the production of one or more hop plant metabolites comprising applying an effective amount of at least one elicitor, wherein the elicitor is a jasmonate or a salicylate, or a combination thereof. The disclosure further relates to methods and compositions for hop plant pest and pathogen control comprising applying an effective amount of at least one elicitor, wherein the elicitor is a jasmonate or a salicylate, or a combination thereof. The disclosure further teaches compositions comprising effective amounts of the elicitors disclosed herein.

### Hop

Cannabaceae is a small family of flowering plants. As now circumscribed, the family includes about 170 species grouped in about 11 genera, including Cannabis (hemp, marijuana), Humulus (hops) and Celtis (hackberries). Members of the family are erect or climbing plants with petal-less flowers and dry, one-seeded fruits. Hemp (Cannabis) and hop (Humulus) are the only economically important species.

Humulus is described as a twining perennial herbaceous plant which sends up new shoots in early spring and dies back to the cold-hardy rhizome in autumn. Example species of hop (Humulus) include Humulus americanus Nutt., Humulus cordifolius Miq., Humulus lupulus L., Humulus neomexicanus (A. Nelson & Cockerell) Rydb., Humulus pubescens (E. Small) Tembrock, Humulus scandens (Lour.) Merr. (syn. Humulus japonicus Siebold & Zucc.), and Humulus yunnanensis Hu.

Particularly, Humulus lupulus L., also known as common hop, is an herbaceous, perennial climbing vine, a dioecious plant belonging to the Cannabaceae family, widely cultivated throughout the temperate regions of the world for the brewing industry as a source of flavour-active secondary metabolites, bitter acids, and shelf-life stabilizer. In addition, hop extracts and/or metabolome has received considerable attention in pharmaceutical applications due to their diverse biological properties, such as anti-carcinogenic, anti-inflammatory, estrogenic, sedative, antimicrobial, and antioxidant activities.

The hop plant is a valuable source of several secondary metabolites, such as flavonoids, bitter acids, and essential oils. These compounds are widely implicated in the beer brewing industry and have potential biomedical applications. The female plants of hop produce cone-like inflorescences, commonly referred to as “hop cones” or “hops” contain a large number of highly metabolically active glandular trichomes (lupulin glands) on the inner side of bracts and bracteoles, which synthesize and/or secret specific secondary metabolites such as essential oils, bitter acids (humulone or α-acid and lupulone or β-acid) that are essential for the brewing of beer, and prenylated flavonoids (xanthobumol and desmethylxanthohumol) that exhibit interesting bioactive properties, during its phased maturation (Patzak J et al., Int J Food Sci Technol. 2015; 50 (9): 1864-72). In addition to cones, lupulin glands are also sparsely distributed on the undersides of leaves, containing hop acids, terpenes, xanthohumol and flavonols and thus serve as the primary site of secondary metabolite accumulation (Mishra, A. K. et al., BMC Genomics 19, 739 (2018). During development from female inflorescences to cones, levels of α-acids, β-acids, desmethylxanthohumol, and xanthohumol gradually increase, while each hop variety exhibits individual accumulation rates. Furthermore, these compounds are present in leaves of fully grown hops as well.

Secondary metabolites of hop (Humulus lupulus L.) are produced in the lupulin glands of the female hop flowers and represent 15-30% by weight of the dried cones. Whereas bitter acids give beer its bitterness, hop oils provide aroma and flavour. The composition of hop essential oils is complex and more than 450 volatiles have already been identified (Roberts, M. et al., (2004) J. Sep. Sci. 27, 473-478). Hop oil constituents are generally classified into three chemical groups: hydrocarbons, oxygenated compounds, and organosulphur compounds accounting for 60-80, 20-40 and <1% of total hop oil, respectively. The major constituents are hydrocarbon terpenes, the monoterpene myrcene and sesquiterpenes β-caryophyllene, α-humulene, β-farnesene and selinenes. Oxygenated compounds fall into several classes including alcohols, ketones and esters. Also, terpenoic compounds, such as linalool, geraniol and humulene epoxides, are present (Peacock, V. (2010) Tech. Q. Master Brew. Assoc. Am. 47, 29-32).

Meanwhile, prenylated flavonoids are known to exhibit very interesting physiological activity, which include xanthobumol, desmethylxanthobumol (DMX), and 8-Prenylnaringenin. For example, xanthohumol exhibits extensive antitumor activity. 8-Prenylnaringenin exhibits the most potent estrogenic activity.

The present disclosure relates to the inventors' novel discovery that elicitors, such as jasmonates, can cause a cascading biochemical reaction within a hop plant's biosynthetic pathways, encouraging the hop plant to alter metabolite production.

Hop cones that have altered concentrations of alpha acids, beta acids, terpenes, thiols, and other secondary metabolites can provide a number of benefits to hops growers and the brewing industry, including, but not limited to, the following characteristics:
1) Bittering: Alpha acids are the primary bittering compounds in hops. A higher concentration of alpha acids in the hops cones can lead to a more bitter beer.
2) Aroma: Beta acids and terpenes are responsible for the aroma of hops. A higher concentration of these compounds in the hops cones can lead to a more aromatic beer.
3) Flavor: Secondary metabolites such as thiols contribute to the flavour of beer. A higher concentration of these compounds in the hop cones can lead to a more complex and nuanced flavour profile.
4) Preservation: Hops contain natural preservatives, such as alpha and beta acids, which can help to preserve the beer and extend its shelf life.
5) Disease resistance: Hop plants with higher concentrations of secondary metabolites may be more resistant to pests and diseases, which can improve yields and reduce the need for chemical pesticides.

Hop breeding programs have been working to produce new varieties with altered concentrations of these compounds, which can help to improve the quality of beer and make it more desirable to brewers and consumers. As disclosed herein, the inventors have surprisingly discovered that application of an elicitor herein can provide beneficial alteration to metabolite production in existing hops varieties, without requiring re-planting of hop vineyards. When applied to hops, the inventors have shown that MDJ alters the production of metabolites of interest, including certain acids, thiols, terpenes, and other compounds that determine the quality of hops and, ultimately, the quality of the beer they produce.

### Methods of Altering Secondary Metabolite Content in a Hop Plant or Plant Part

In some embodiments, the methods and compositions disclosed herein alter the synthesis of a secondary metabolite in a hop plant, plant part, or plant cell compared to untreated plants and plant parts. In some embodiments, the method comprises applying an effective amount of at least one elicitor, wherein the elicitor is a jasmonate. In some embodiments, the method comprises applying an effective amount of at least two jasmonates. In some embodiments, the method comprises applying an effective amount of at least three jasmonates.

In some embodiments, the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.

In some embodiments, the at least one elicitor is methyl jasmonate. In some embodiments, the at least one elicitor is methyl dihydrojasmonate. In some embodiments, the at least one elicitor is cis-jasmone. In some embodiments, the at least two jasmonates are methyl jasmonate and methyl dihydrojasmonate. In some embodiments, the at least two jasmonates are methyl jasmonate and cis-jasmone. In some embodiments, the at least two jasmonates are methyl dihydrojasmonate and cis-jasmone. In some embodiments, the at least three jasmonates are methyl jasmonate, methyl dihydrojasmonate, and cis-jasmone.

In some embodiments, the method further comprises applying an effective amount of a non-jasmonate elicitor. In some embodiments, the non-jasmonate elicitor is a salicylate. In some embodiments, the salicylate is methyl salicylate and/or salicylic acid.

### Primary Metabolites

The disclosed compositions and methods may be used to increase crop value by contacting young plants, seeds, clones or scions, vegetative plants, or other non-reproductive plant parts, or reproductive plant parts with an elicitor to induce a desired response. The value of the crop may be determined by quantifying the concentration of metabolites in plant parts, for example, with mass spectrometry, or by weight or volume measurements, or yield (concentration, weight, density, or relative abundance) of structures or organs, or by other physical or chemical means.

In some embodiments, the compositions and methods can be used to increase the production of valuable metabolites, or to decrease the production of undesirable metabolites, as determined by analysis of plant or plant parts.

In addition to primary metabolites, the quality of the hop (and beer resulting therefrom) is determined largely by secondary metabolites.

### Secondary Metabolites

Secondary metabolites are compounds which are not required for the growth and reproduction of the organism, but provide some advantage to the organism (bacteria, fungi, and plants) and may be required for survival. For example, a secondary metabolite may attract a pollinator through color or scent, or provide defense from an invading bacterial, viral, or fungal species. They may confer protection from UV radiation, or an insect pest, or aid in wound healing. They are also responsible for the aromas and flavors of plants (which may deter predators). They can be classified based on their chemical structures. Exemplary classes of secondary metabolites include phenolics (tanins, coumarins, flavonoids, chromones and xanthones, stilbenes, lignans), alkaloids, and terpenes. Hops are valued for their secondary metabolites, including bitter acids, flavonoids, essential oils, and polyphenols. In some embodiments, the compositions and methods disclosed herein are used for altering secondary metabolite production in hop plants. In some embodiments, methods and compositions disclosed herein alter the synthesis of at least one of a bitter acid, essential oil, odorant, polyphenol, thiol, flavonoid, phenolic, alkaloid, or terpene.

### Bitter Acids

In some embodiments, the compositions and methods disclosed herein alter hop bitter acid production. In some embodiments, the compositions and methods increase bitter acid production. In some embodiments, the compositions and methods decrease bitter acid production. Hop bitter acids include alpha acids and beta acids.

Alpha acids. By “alpha acid” or “α-acid” is meant an organic acid derived from a hop plant (Humulus lupulus) consisting of or having structural homology to a humulone, adhumulone, cohumulone, or an analog or derivative thereof. Humulone, adhumulone, and cohumulone are the three most abundant alpha acids. Other exemplary derivatives of an alpha acid include, but are not limited to isoalpha acids, rhoisoalpha acids, tetrahydroisoalpha acids, and hexahydroisoalpha acids.

Alpha acids are the principal components in lupulin, the resin of the hop cone. They are of great interest to brewers because they are the main bittering agent in hops. Chemically, alpha acids reside in the soft-resin fraction of the lupulin, which is soluble in hexane. They are expressed as a percentage of the total weight of the hop and exist as complex hexagonal molecules. Alpha acid analogues include humulone, cohumulone, and adhumulone, which, when isomerized to isohumulones (iso-alpha acids) through the boiling process, bring bitterness to beer. Alpha acids in their non-isomerized form are insoluble in aqueous solutions such as beer. They are precursors to the isomerized compounds that are measurable in finished beer. Higher levels of cohumulone are an indicator for potentially harsh bitterness.

The alpha acid level of hops is measured in a laboratory. When dissolved in beer as iso-alpha acids, the unit of measurement for bitterness is International Bitterness Units. The hops' alpha acid value is then used by the brewer to formulate a recipe for the beer's final bitterness. Brewers adjust hopping rates based primarily on the selected hop's alpha acid content expressed as a percentage of the hop's weight (commonly in a range of 2%-18%) and on the expected utilization rate of that hop in a given brewing system during a particular brewing process.

Hop varieties are often grouped into four categories based on their alpha acid content. There are the low-alpha aroma varieties with alpha acid levels of about 2.5%-6%; there are dual-purpose varieties with alpha acid levels of about 6%-10%; there are high-alpha bittering varieties with alpha acid levels of about 10%-15%; and then there are super alpha bittering varieties with alpha acid levels of about 14%-18%. Some recent experimental hop plantings have even been assayed at 22%. Many high- and super alpha varieties find their way into hop extract production and are ultimately sold solely for their alpha acid content. Experimental craft brewers, however, have adopted a few super alpha varieties for their unique flavor characteristics.

World hop production is often measured by the total amount of alpha acids produced in a given harvest year. The annual world alpha acid demand is currently between 7,000 and 7,500 metric tons.

In some embodiments, methods and compositions herein decrease alpha acid production. In some embodiments, methods and compositions herein increase alpha acid production. In some embodiments, the content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is decreased by about 1, 2, 3, 4, 5, 6, 7, 8, 9, 10, 11, 12, 13, 14, 15, 16, 17, 18, 19, or 20-fold, including all values and sub-ranges therebetween.

Beta acids. By “beta acid” or “β-acid” is meant an organic acid derived from a hop plant (Humulus lupulus) consisting of or having structural homology to a lupulone, adlupulone, colupulone or an analog or derivative thereof. Lupulone, adlupulone, and colupulone are the three most abundant beta acids.

Beta acids make up part of the soft resins in hops. They have very low solubility in wort (~1 part per million); thus, only trace amounts survive the brewing process and end up in finished beer. Beta acids are fairly reactive with oxygen and can oxidize to a set of compounds called hulupones, each of which is derived from its beta acid analogue; for instance, cohulupulone comes from colupulone. Because they are not bitter and are only marginally soluble, beta acids do not directly contribute to beer flavor. However, hulupones are bitter and can contribute substantially to the final flavor of beer. Hulupones are relatively stable once formed and can survive all stages of the brewing process. They can be formed via the oxidative degradation of hops during storage. As hops oxidize, the bitterness that comes from iso-alpha acids diminishes because their precursors, alpha acids, are lost as a result of oxidation, but this is somewhat offset by the presence of bitterness from the hulupones. The ratio of alpha acids to beta acids ultimately dictates the degree to which the bitterness potential will diminish as hops oxidize. Higher levels of beta acids in the raw hops will result in a slower decline of bittering power as hops degrade oxidatively because of the resultant higher levels of hulupones.

In some embodiments, methods and compositions herein decrease beta acid production. In some embodiments, methods and compositions herein increase beta acid production. In some embodiments, the content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is decreased by about 1, 2, 3, 4, 5, 6, 7, 8, 9, 10, 11, 12, 13, 14, 15, 16, 17, 18, 19, or 20-fold, including all values and sub-ranges therebetween.

### Terpenes

Terpenes are a large and diverse class of organic compounds, produced by a variety of plants. They are often strong smelling and thus may have had a protective function. Terpenes are derived biosynthetically from units of isoprene, which has the molecular formula C₅H₈. The basic molecular formulae of terpenes are multiples of that, (C₅H₈)ₙ where n is the number of linked isoprene units. The isoprene units may be linked together “head to tail” to form linear chains of they may be arranged to form rings. Non-limiting examples of terpenes include Hemiterpenes, Monoterpenes, Sesquiterpenes, Diterpenes, Sesterterpenes, Triterpenes, Sesquarterpenes, Tetraterpenes, Polyterpenes, and Norisoprenoids.

Terpenoids, a.k.a. isoprenoids, are a large and diverse class of naturally occurring organic chemicals similar to terpenes, derived from five-carbon isoprene units assembled and modified in thousands of ways. Most are multicyclic structures that differ from one another not only in functional groups but also in their basic carbon skeletons. Plant terpenoids are used extensively for their aromatic qualities. They play a role in traditional herbal remedies and are under investigation for antibacterial, antineoplastic, and other pharmaceutical functions. The terpene Linalool for example, has been found to have anti-convulsant properties (Elisabetsky et al., Phytomedicine, May 6 (2): 107-13 1999). Non-limiting examples of terpenoids include, Hemiterpenoids, 1 isoprene unit (5 carbons); Monoterpenoids, 2 isoprene units (10C); Sesquiterpenoids, 3 isoprene units (15C); Diterpenoids, 4 isoprene units (20C) (e.g. ginkgolides); Sesterterpenoids, 5 isoprene units (25C); Triterpenoids, 6 isoprene units (30C) (e.g. sterols); Tetraterpenoids, 8 isoprene units (40C) (e.g. carotenoids); and Polyterpenoid with a larger number of isoprene units.

Terpenoids are mainly synthesized in two metabolic pathways: mevalonic acid pathway (a.k.a. HMG-COA reductase pathway, which takes place in the cytosol) and MEP/DOXP pathway (a.k.a. The 2-C-methyl-D-erythritol 4-phosphate/1-deoxy-D-xylulose 5-phosphate pathway, non-mevalonate pathway, or mevalonic acid-independent pathway, which takes place in plastids).

In some embodiments, the production of terpenes and terpenoids derived from isoprone units, including acyclic, monocyclic, bicyclic, tricyclic, tetracyclic, pentacyclic, hexacyclic, heptacyclic, and octacyclic cyclisations of hemiterpenes, monoterpenes, sesquiterpenes, diterpenes, sesterterpenes, triterpenes, sesquarterpenes, tetraterpenes, and polyterpenes are manipulated independently of each other. In some embodiments, the production of terpenes and terpenoids derived from isoprene units, including acyclic, monocyclic, bicyclic, tricyclic, tetracyclic, pentacyclic, hexacyclic, heptacyclic, and octacyclic cyclisations of hemiterpenes, monoterpenes, sesquiterpenes, diterpenes, sesterterpenes, triterpenes, sesquarterpenes, tetraterpenes, and polyterpenes are manipulated relative to each other.

The most abundant terpenes in hops are usually myrcene, β-farnesene, caryophyllene and humulene.

In some embodiments, methods and compositions herein alter production of a terpene in a hop plant, plant part or plant cell. In some embodiments, the terpene is selected from the group consisting of myrcene, β-farnesene, caryophyllene, and humulene. In some embodiments, the terpene is 2-undecanone, α-pinene, β-ionone, β-pinene, caryophyllene, caryophyllene oxide, citral, citronellene, farnesene, geraniol, geranyl acetate, humulene, limonene, linalool, methyl laurate, methyl octanoate, methyl thiohexanoate, methyl heptanoate, myrcene, nerol, nerolidol, ocimene, or terpinolene. In some embodiments, methods and compositions herein decrease the content of a terpene. In some embodiments, methods and compositions herein increase the content of a terpene. In some embodiments, the terpene content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the terpene content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the terpene content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the terpene content is decreased by about 1, 2, 3, 4, 5, 6, 7, 8, 9, 10, 11, 12, 13, 14, 15, 16, 17, 18, 19, or 20-fold, including all values and sub-ranges therebetween.

### Oil

In some embodiments, the compositions and methods disclosed herein alter hop oil production. The essential oil of hops (Humulus lupulus L.) imparts odor and aroma characteristics to beer. Hop essential oils can influence beer aroma in terms of floral, spicy, herbal, woody and fruity characters. There are a large number of hop varieties commercially available with distinct odor characteristics, which can be attributed in part to the different composition of their essential oils. This composition is complex, potentially containing up to 1,000 compounds from a wide range of chemical classes. Fresh essential oil is dominated by terpene hydrocarbons, predominantly myrcene, α-humulene and β-caryophyllene.

In some embodiments, the total oil percentage (w/w) is altered. In some embodiments, the total oil is increased. In some embodiments, the total oil is decreased. In some embodiments, the content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is decreased by about 1, 2, 3, 4, 5, 6, 7, 8, 9, 10, 11, 12, 13, 14, 15, 16, 17, 18, 19, or 20-fold, including all values and sub-ranges therebetween.

### Odorants

In some embodiments, the methods and compositions herein alter the odorant content of a hop plant. Due to its abundance, myrcene is important for the odor of fresh hop essential oil. Linalool and geraniol have been determined to be important odorants contributing to the floral character of hop essential oil and beer. Other compounds such as β-ionone, β-damascenone, geranial, neral, trans-4,5-epoxy-(E)-2-decenal, 1,3 (E),5 (Z)-undecatriene, 1,3 (E),5 (Z), 9-undecatetrene, ethyl 2-methylpropanoate, methyl 2-methyl-butanoate, propyl 2-methylbutanoate, (Z)-1,5-octadien-3-one, nonanal and isovaleric acid have been implicated as potent odorants in hop essential oil. In some embodiments, an odorant is increased. In some embodiments, an odorant is decreased. In some embodiments, the content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is decreased by about 1, 2, 3, 4, 5, 6, 7, 8, 9, 10, 11, 12, 13, 14, 15, 16, 17, 18, 19, or 20-fold, including all values and sub-ranges therebetween.

### Polyphenols

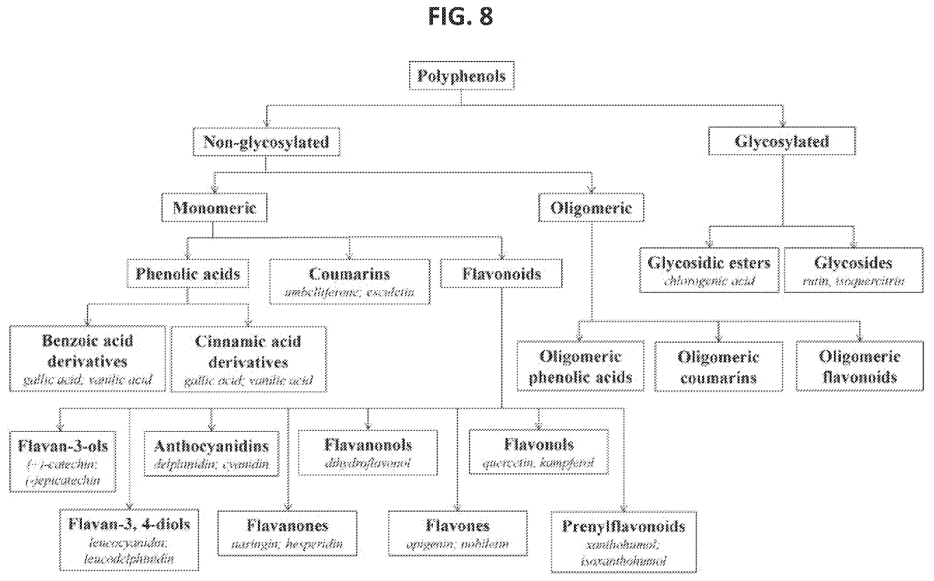

Hop polyphenols represent a very broad and heterogeneous group of secondary metabolites with very different chemical structures. About 1000 polyphenolic substances have been found in hop cones. These polyphenols account for about three to eight percent of dry hop cones. Polyphenols are generally found in the green part of the cone. Only prenylflavonoids are present, together with hop resins and essential oils in lupulin granules. Hop polyphenols can be divided into 2 groups: non-glycosylated and glycosylated polyphenols. Non-glycosylated polyphenols consist of monomeric and oligomeric forms. Major oligomeric hop flavonoids are called tannins. Hop monomeric acids consist of phenolic acids (gallic acids, vanillic acids), coumarins (umbeliferone, esculetin), and flavonoids. The flavonoid group consists of flavan-3-ols ((+)-catechin, (−)-epicatechin), anthocyanidins, flavonols (quercetin, kaemferol), flavanonols, and prenylflavonoids (isoxanthohumol, XN). Xanthohumol, more precisely, belongs to the group of prenylated chalcones. Major glycosylated polyphenols are from group of glycosides (rutin, isoquercitrin). Rutin and isoquercitrin are glycosylated quercetins (α-1-rhamnopyranosyl-(1→6)-β-d-glucopyranose and quercetin 3-O-β-d-glucopyranoside). Hop polyphenols and prenylflavonoids have received significant research attention in the last several years due to their health effects. Important prenylflavonoids of hop include XN, isoxanthohumol (IXN), and desmethylxantohumol (DMX). See FIG. 8, depicting illustrative polyphenols of the present disclosure.

In some embodiments, the compositions and methods herein alter the content of a polyphenol in a hop plant or plant part. In some embodiments, the content of a polyphenol is increased. In some embodiments, the content of a polyphenol is decreased. In some embodiments, the content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the content is decreased by about 1, 2, 3, 4, 5, 6, 7, 8, 9, 10, 11, 12, 13, 14, 15, 16, 17, 18, 19, or 20-fold, including all values and sub-ranges therebetween.

### Thiols

Thiols are a family of sulfur-containing aroma compounds naturally found in hops, either as free aroma-active volatiles or as non-aroma-active (i.e. non-volatile) precursors. They represent only 1% of the total hop oil composition and are categorized as the sulfur fraction. Despite their low concentrations, thiols have very low sensory detection thresholds, meaning they are perceived at exceptionally low concentrations. Volatile thiols are considered responsible for popular “tropical” or “passion fruit” flavors in beer. These compounds are derived during the fermentation process by the action of yeast beta-lyase on non-volatile cysteine- or glutathione-S-conjugate precursors. Several important thiols in hops include 4-mercapto-4-methyl-pentan-2-one (4MMP), 3-mercaptohexanol (3MH), and 3-mercaptohexyl acetate (3MHA).

In some embodiments, the methods and compositions herein alter production of a thiol in a hop plant or plant part. In some embodiments, the thiol is dimethyl sulfide/2-mercaptoethanol; 4-MMP; dimethyl trisulfide; 3-mercapto-3-methylbutanol; methyl thiohexanoate; 3-mercaptohexan-1-ol (3MH); or 3-mercapto-4-methylpentylacetate/3-mercaptohexyl acetate (3MHA). In some embodiments, the thiol content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the thiol content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the thiol content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the thiol content is decreased by about 1, 2, 3, 4, 5, 6, 7, 8, 9, 10, 11, 12, 13, 14, 15, 16, 17, 18, 19, or 20-fold, including all values and sub-ranges therebetween.

### Phenolics

Phenolic compounds are a large group of secondary metabolites, characterized by the presence of at least one phenol group, but may be further grouped as simple phenolics, tannins, coumarins, flavonoids, chromones and xanthones, stilbenes, and lignans. They are an important component of the human diet and have numerous health benefits, including for example, as an antioxidant, antimicrobial, anticancer, anti-inflammatory, and anti-mutagenic. They may also be used in personal care items, and as a food preservative (Kumar N, Goel N. Phenolic acids: Natural versatile molecules with promising therapeutic applications. Biotechnol Rep (Amst). 2019; 24; Lin D, et al. An Overview of Plant Phenolic Compounds and Their Importance in Human Nutrition and Management of Type 2 Diabetes. Molecules. 2016; 21 (10): 1374.).

In some embodiments, the methods and compositions disclosed herein alter the production of a phenolic in a hop plant, plant part, or plant cell. In some embodiments, the phenolic is a simple phenolic, tannin, coumarin, flavonoid, chromone, xanthone, stilbene, or lignan. In some embodiments, the phenolic is a simple phenolic, flavonoid, or stilbenoid. Simple phenolics are so named because they have a single benzene (aromatic) ring. In some embodiments, the methods and compositions disclosed herein alter the production of a simple phenolic in a hop plant, plant part, or plant cell.

In some embodiments, the methods and compositions disclosed herein alter the production of a phenolic. In some embodiments, the phenolic content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the phenolic content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the phenolic content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the phenolic content is decreased by about 1, 2, 3, 4, 5, 6, 7, 8, 9, 10, 11, 12, 13, 14, 15, 16, 17, 18, 19, or 20-fold, including all values and sub-ranges therebetween.

### Flavonoids

Flavonoids represent a large family of secondary metabolites having the general structure of two phenyl rings and a heterocyclic ring. Nearly 6000 structures have been identified in plants (Hichri I, et al., Recent advances in the transcriptional regulation of the flavonoid biosynthetic pathway. J Exp Bot. 2011 May; 62 (8): 2465-83). They have diverse biological roles, including for example, antioxidant, anti-inflammatory, and antimicrobial effects.

Flavonoids are the most abundant polyphenols in the human diet and are considered health-promoting compounds due to their antioxidant and anti-inflammatory activities. As such, some flavonoids are extracted from plants and used in health supplements (see for example International Publication No. WO/2020197828 and U.S. Pat. No. 6,544,581). High flavonoid consumption has been correlated to prevention of cancers, cardiovascular diseases, Alzheimer's, and atherosclerosis (Babu et ah, 2009, Hollman and Katan, 1999, Kris-Etherton et ah, 2004).

Flavonoids can be subgrouped into flavones (i.e., apigenin, tangeretin, baicalein, rpoifolin), isoflavones (i.e., genistin, genistein, daidzein, glycitein, daidzin), flavonols (also known as catechins or flavan-3-ols) (i.e., quercetin, myricetin, rutin, morin, kaempferol), flavonones (i.e., hespertin, naringin, naringenin, eriodictyol, hesperidin), anthocyanins (i.e., cyanidin, malvidin, delphinidin, peonidin), and chalcones (i.e., phloretin, arbutin, phlioridzin, chalconaringenin). Among the health benefits of flavonols, kaempferol was found to reduce the risk of chronic diseases including cancer (Chen et ak, 2013), quercetin was linked to increasing the lifespan extension in mammals (Haigis et ak, 2010) and myricetin was found to reduce the risks of cancer and diabetes (Feng et ak, 2015).

Flavonoids are phenolic derivatives with a flavan or chalcone flavonoid skeleton and have many beneficial effects on human health. This is especially true of prenylflavonoids, which have so far been identified in 37 of plant genera, mainly in the families of Leguminosae, Moraceae, Guttiferae, Umbelliferae, Rutaceae and Cannabaceae. These compounds differ in the position of the prenyl group, the number of attached isoprenoid units and modifications of the prenyl moiety, such as cyclization and hydroxylation. Prenylated flavonoids are accumulated in lupulin glands that cover bract of female hop cones. Their common precursor compound xanthohumol (XN), a prenylated chalcone, is the principal prenylflavonoid in the female flowers of the hop plant Humulus lupulus L. and provides 80-90% of its total flavonoid content.

The major prenylflavonoids of hop are xanthohumol and desmethylxanthohumol (DMX). During the brewing process, both are converted into their isomeric flavanones isoxanthohumol, 6-prenylnaringenin and 8-prenylnaringenin. Hop flavonoids, particularly xanthohumol (XN), are substances with hypoglycemic, antihyperlipidemic, and antiobesity activities.

XN was extensively studied in the past and is considered the most active ingredient in hop and beer. It demonstrated chemopreventive activity, inhibiting initiation and development of carcinogenesis in human body and therapeutic activity, by inducing cytotoxic effect and apoptosis in the existing tumour cells. In addition, it positively affects glucose and lipid metabolism, hepatic and intestinal metabolism and many others activities.

During beer production, high temperature causes isomerization XN to IXN which become a major prenyl flavonoid present in beer; however, in the hydrophobic environment of plant cells, isomerization of XN to IX was not observed, hence hop's prenyflavanones are represented by IXN, which is only about 0.01% of dry matter. 8-PN has been identified in an amount of 0.002% of dry matter of hops, as well as 6-PN which is present in slightly higher amounts (0.01%). Both compounds are produced from DMX in small quantities in a non-enzymatic manner during the drying, storage and extraction of hops.

In some embodiments, the methods and compositions disclosed herein alter the production of a flavonoid in a hop plant, plant part, or plant cell. In some embodiments, the flavonoid is a flavone, an isoflavone, a flavan-3-ol, a flavonone, an anthocyanin, catechin, or a chalcone. In some embodiments, the flavonoid is XN, IXN, DMX, 8-PN, or 6-PN.

In some embodiments, the methods and compositions disclosed herein alter the production of a flavonoid. In some embodiments, the flavonoid content is increased by about 5, 10, 15, 20, 25, 30, 35, 40, 45, 50, 55, 60, 65, 70, 75, 80, 85, 90, 95, or about 100%, including all values and sub-ranges therebetween. In some embodiments, the flavonoid content is increased by about 1, 2, 3, 4, 5, 6, 7, 8, 9, 10, 11, 12, 13, 14, 15, 16, 17, 18, 19, or 20-fold, including all values and sub-ranges therebetween. In some embodiments, the flavonoid content is decreased by about 5, 10, 15, 20, 25, 30, 35, 40, 45, 50, 55, 60, 65, 70, 75, 80, 85, 90, 95, or about 100%, including all values and sub-ranges therebetween. In some embodiments, the flavonoid content is decreased by about 1, 2, 3, 4, 5, 6, 7, 8, 9, 10, 11, 12, 13, 14, 15, 16, 17, 18, 19, or 20-fold, including all values and sub-ranges therebetween.

In some embodiments, the methods and compositions disclosed herein alter the production of a tannin in a hop plant, plant part, or plant cell.

### Stilbenes and Stilbenoids

Stilbenes and their derivatives stilbenoids are composed of two benzene rings joined by ethanol or ethylene. More than 400 stilbenes have been identified (T. Shen, X.-N. Wang, and H.-X. Lou, “Natural stilbenes: an overview,” Natural Product Reports, vol. 26, no. 7, pp. 916-935, 2009).

Stilbenoids (1,2-diarylethenes) are another class of phenolic compounds (non flavonoids) present in plants. Like other secondary metabolites, stilbenoid content can be affected by a number of factors, for example, climate, variety, and pests. Currently, there is a high demand for stilbenes due to their valuable pharmacological properties and role as phytoalexins.

In some embodiments, the methods and compositions disclosed herein alter the production of a stilbene in a hop plant, plant part, or plant cell. In some embodiments, the methods and compositions disclosed herein increase the stilbene content in a hop plant, plant part, or plant cell. In some embodiments, the methods and compositions disclosed herein decrease the stilbene content in a hop plant, plant part, or plant cell.

### Lignans

Lignans are a complex polymeric material made up of simple phenolics. In some embodiments, the methods and compositions disclosed herein alter the production of a lignan in a hop plant, plant part, or plant cell.

### Alkaloids

Alkaloids are diverse compounds containing nitrogen in a heterocyclic ring, and have been found in diverse plants. Alkaloids have diverse therapeutic uses including, for example, anesthesia, analgesia, cardiac stimulation, respiratory stimulation and relaxation, vasoconstriction, muscle relaxation and toxicity, as well as antineoplastic, hypertensive and hypotensive properties.

In some embodiments, the methods and compositions disclosed herein alter the production of an alkaloid in a hop plant, plant part, or plant cell.

### Elicitors

Certain biochemicals are known to function endogenously within the plant and play roles within plant hormone signal transduction. Jasmonic Acid (JA) and Salicylic Acid (SA), which correspond to the Jasmonic Acid pathway and Salicylic Acid pathway in higher plants are responsible for modulating plant responses to abiotic and biotic stimuli. These biosynthetic pathways derive from alpha-linolenic acid metabolism and phenylalanine metabolism, respectively, and in some plant species are antagonists of each other; when JA pathways are upregulated, SA pathways are repressed, and vice versa. This phenomenon can be described in one sense by the chemical's relationship to the octadecanoid pathway, which is responsible for the production of jasmonic acid. Salicylates demonstrate negative crosstalk with jasmonates and likewise are considered inhibitors of the octadecanoid pathway.

Jasmonic acid is one of several endogenous lipid-based octadecanoid derivatives that are known to act as elicitors of plant defense, along with its methyl ester (methyl jasmonate, MeJA) and other derivatives (Saniewski M. (1997) The Role of Jasmonates in Ethylene Biosynthesis. In: Kanellis A. K., Chang C., Kende H., Grierson D. (eds) Biology and Biotechnology of the Plant Hormone Ethylene. NATO ASI Series (3. High Technology), vol 34). Jasmonates generally follow the same fundamental biosynthetic steps in plants, starting with the oxygenation of alpha-linolenic acid by lipoxygenase (13-LOX), which cyclizes to form allene oxide and then rearranges to form 12-oxophytodienoic acid (12-OPDA), which is then transformed into 7-iso-jasmonic acid via R-oxidations and can isomerize into JA. JA can then decarboxylate into the bioactive cis-jasmone (CJ), conjugate with isoleucine to produce JA-11e, or be metabolized into Methyl Jasmonate (MeJA), among others (Matsui, R., et al. Elucidation of the biosynthetic pathway of cis-jasmone in Lasiodiplodia theobromae. Sci Rep 7, 6688 (2017)).

Jasmonate derivatives, or derivatives of the octadecanoid pathway comprised of a cyclopentanone ring, cyclopentene ring, or other ketone may include an alkane chain or an alkene chain, or may include a different hydrocarbon chain and may include a carboxylic acid side chain of different lengths.

Shown below is the structure for Methyl Jasmonate (MeJA) (from National Center for Biotechnology Information (2021), PubChem Compound Summary for CID 5281929, Methyl jasmonate).

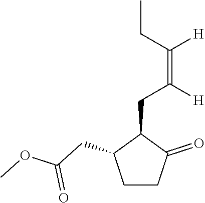 [SMILES: CC/C=C\C[C@H]1C(=O)CC[C@@H]1CC(=O)OC]

Shown below is the structure for methyl dihydrojasmonate (MDJ) (National Center for Biotechnology Information (2021). PubChem Compound Summary for CID 102861, Methyl dihydrojasmonate).

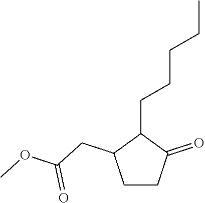 [SMILES: CCCCCC1C(=O)CCC1CC(=O)OC]

Shown below is the structure for cis-jasmone (CJ) (National Center for Biotechnology Information (2021). PubChem Compound Summary for CID 1549018, Jasmone).

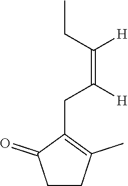

All jasmonates and even jasmonate-like molecules, including (+)-cucurbic acid and tuberonic acid, share some similarities in their chemical structures, such as cyclopentanone rings. However specific jasmonate-type responses in plants may be structure dependent and based on the presence of hydroxyl groups, methyl groups, hydrocarbon chains, carboxylic acid chains, or other functional groups, or may be dependent on the chirality of each jasmonate type compound, or may be dependent on the compound's stereoisomerism, or may be dependent on the compound's spatial isomerism, or otherwise dependent on the structure.

Prohydrojasmone (PDJ) is a synthetic derivative of jasmonic acid previously shown to increase anthocyanain and bring about the red color in apples (BLUSH™). Methyl dihydrojasmonate is only produced endogenously in a few plants, thus its ability to function as an elicitor was previously unresearched. Additionally, jasmonate derivatives like cis-jasmone (CJ) may be used to elicit more specific responses when applied exogenously in planta in comparison to the standard jasmonate elicitors like JA and MeJA.

### Methods of Altering the Production of a Plant Metabolite

In some embodiments, the present disclosure teaches a method for altering the production of one or more plant metabolites in a plant, plant part, or plant cell, comprising: applying an effective amount of at least one elicitor to the plant, plant part, or plant cell, wherein the at least one elicitor is a jasmonate.

In some aspects, the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof. In some embodiments, the jasmonate is a synthetic. In some aspects, the jasmonate is methyl jasmonate. In some aspects, the jasmonate is methyl dihydrojasmonate. In some aspects, the jasmonate is cis-jasmone.

In some aspects, the method comprises applying an effective amount of a composition comprising two or more jasmonates. In some aspects, the method comprises applying an effective amount of a composition comprising three jasmonates.

In some aspects, the method further comprises applying a non-jasmonate elicitor. In some aspects, the non-jasmonate elicitor is a salicylate. In some aspects, the salicylate is methyl salicylate and/or salicylic acid.

In some embodiments, the present disclosure teaches a method for altering the production of one or more plant metabolites in a plant, plant part, or plant cell, comprising applying an effective amount of a salicylate to the plant, plant part, or plant cell. In some aspects, the salicylate is methyl salicylate and/or salicylic acid. In some aspects, the method further comprises applying a jasmonate, wherein the jasmonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof.

### Compositions Comprising Jasmonate Elicitors

In some embodiments, present disclosure teaches compositions comprising at least one jasmonate and a surfactant, wherein the at least jasomonate is selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and their homologues or analogues, isomers, derivatives or conjugates thereof. In some aspects, the composition comprises methyl dihydrojasmonate. In some aspects, the composition comprises cis-jasmone.

In some aspects, the compositions comprise two jasmonates. In some aspects, the two jasmonates are methyl jasmonate and methyl dihydrojasmonate. In some aspects, the two jasmonates are methyl jasmonate and cis-jasmone. In some aspects, the two jasmonates are methyl dibydrojasmonate and cis-jasmone. In some aspects, the composition comprises three jasmonates. In some aspects, the three jasmonates are methyl jasmonate, methyl dihydrojasmonate, and cis-jasmone

In some embodiments, the disclosure relates to a composition comprising methyl dibydrojasmonate and plant tissue and/or plant cells from a hop plant.

By the term “surfactant” it is understood that wetting agents, surface-active agents or surfactants, dispersing agents, suspending agents, emulsifying agents, and combinations thereof, are included therein. Ionic and non-ionic surface-active agents can be used.

Examples of non-ionic surface-active agents include, but are not limited to, alkoxylates, N-substituted fatty acid amides, amine oxides, esters, sugar-based surfactants, polymeric surfactants, and mixtures thereof, allinol, nonoxynol, octoxynol, oxycastrol, oxysorbic (for example, polyoxyethylated sorbitol fatty-acid esters, thalestol, and polyethylene glycol octylphenol ether (TRITON®). In some embodiments, the surfactant is polysorbate-20.

Examples of ionic surfactants for use with the compositions described herein may include anionic surfac-tants such as alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sul-fonates, sulfonates of fatty acids and oils, sulfonates of ethoxylated alkylphenols, sulfonates of alkoxylated arylphe-nols, sulfonates of condensed naphthalenes, sulfonates of dodecyl- and tridecylbenzenes, sulfonates of naphthalenes and alkylnaphthalenes, sulfosuccinates or sulfosuccina-mates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl car-boxylates, and carboxylated alcohol or alkylphenol ethoxy-lates.

Persons having skill in the art will be able to formulate the compositions of the present disclosure with appropriate surfactants to allow for plant applications. In some embodiments, the amount of surfactant used is the minimum amount required to get the compound into solution/emulsion, and will generally be 0.1% to 5% by weight.

In some embodiments, the compositions disclosed herein further comprise additives, auxiliaries, and/or excipients. Additional components may act to improve the stability of the composition, improve the homogeneity of the composition, improve the function of the composition in planta, or provide other qualities to the composition and/or to the methodology of the present disclosure. In some embodiments, the composition further comprises amino acids, minerals, salts, solvents, stabilizers, hormones, enzymes, vitamins, chitin, chitosan, carboxylic acids, carboxylic acid derivatives, linoleic acid and other fatty acids, volatile organic compounds (VOCs), microbial consortia or isolates, bioregulators, biostimulants, and other additives known in the art to elicit a biological, biochemical, physiological, and/or physiochemical response from the plant, or to stabilize the composition, or to elicit specific metabolite production in the plant.

The composition may include other active or inactive ingredients. In some embodiments, the composition includes at least one fungicide. Example fungicides include, but are not limited to, azoxystrobin, bifujunzhi, coumethoxystrobin, coumoxystrobin; dimoxystrobin, enes-troburin, enoxastrobin, fenaminstrobin, fenoxystrobin, flufenoxystrobin, fluoxastrobin, jiaxiangjunzhi, kresoxim-methyl, mandestrobin, metominostrobin, orysastrobin, picoxystrobin, pyraclostrobin, pyrametostrobin, pyraox-ystrobin, triclopyricarb, trifloxystrobin, methyl 2-[2-(2,5-dimethy lphenyloxymethy 1) pheny 1]-3-methoxyacry late, pyribencarb, triclopyricarb/chlorodincarb, famoxadon, fena-midon, cyazofamid, amisulbrom, benodanil, bixafen, boscalid, carboxin, fenfuram, fluopyram, flutolanil, fluxapy-roxad, furametpyr, isopyrazam, mepronil, oxycarboxin, pen-flufen, penthiopyrad, sedaxane, tecloftalam, thifluzamide, N-(4′-trifluoromethy Ithio-biphenyl 1-2-yl)-3-difluoromethy 1-1-methy 1-1 H-pyrazole-4-carboxamide, N-(2-(1,3,3-trimeth-ylbutyl)phenyl)-1,3-dimethyl-5-fluoro-1 H-pyrazole-4-car-boxamide, N-[9-(dichloromethylene)-1,2,3,4-tetrahydro-1,4-methanonaphthalen-5-yl]-3-(difluoromethyl)-1-methyl-H-pyrazole-4-carboxamide, diflumetorim, binapacryl, dinobuton, dinocap, meptyl-dinocap, fluazinam, ferimzone, ametoctradin, silthiofam, azaconazole, bitertanol, bromuconazole, cyproconazole, difenoconazole, diniconazole, diniconazole-M, epoxiconazole; fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, imazalil, pefurazoate, prochloraz, triflumizole, pyrimidines, fenari-mol, nuarimol, pyrifenox, triforine, aldimorph, dodemorph, dodemorph acetate, fenpropimorph, tridemorph, fenpropidin, piperalin, spiroxamine, fenhexamid, benalaxyl, benal-axyl-M, kiralaxyl; metalaxyl, metalaxyl-M (mefenoxam), ofurace; oxadixyl, bymexazole, octhilinone, oxolinic acid, bupirimate, benomyl, carbendazim, fuberidazole, thiaben-dazole, thiophanate-methyl, 5-chloro-7-(4-methyl-piperi-din-1-yl)-6-(2,4,6-trifluorophenyl)-[1,2,4]triazolo[1,5-a]pyrimidine, diethofencarb, ethaboxam, pencycuron, fluopicolid, zoxainid, metrafenon, pyriofenon, cyprodinil, mepanipyrim, pyrimethanil, fluoroimide, iprodione, procymidone, vinclozolin fenpiclonil, fludioxonil, quinoxyfen, edifenphos, iprobenfos, pyrazophos, isoprothiolane, dicloran, quintozene, tecnazene, tolclofos-methyl, biphenyl, chloroneb, etridiazole, dimethomorph, flumorph, mandipropamid, pyrimorph, benthiavalicarb, iprovalicarb, valifenal-ate and 4-fluorophenyl N-(1-(1-(4-cyanophenyl) ethanesul-fonyl) but-2-yl) carbamate, propamocarb, propamocarb hydrochloride, ferbam, mancozeb, maneb, metiram, propineb, thiram, zineb, ziram, anilazine, chlorothalonil, captafol, captan, folpet, dichlofluanid, dichlorophen, flusulfamide, hexachlorobenzene, pentachlorophenol, phthalid, tolylfluanid, N-(4-chloro-2-nitrophenyl)-N-ethyl-4-methyl-benzenesulfonamide, guanidine, dithianon, validamycin, polyoxin B, pyroquilon, tricyclazole, carpropamid, dicyclomet, fenoxanil, and mixtures thereof.

In some embodiments, the composition comprises at least one growth regulator. In some aspects, the growth regulator an ethylene inhibitor. In some aspects, the growth regulator is 1-methylcyclopropene (1-MCP).

In some embodiments, the composition may be prepared as a concentrate for industrial application and further dilution or as a fully diluted ready-to-apply composition. In some aspects, the elicitor in a ready-to-apply composition is between 1 mM and 10 mM. In some aspects, the elicitor in a ready-to-apply composition is 1 mM, 2 mM, 3 mM, 4 mM, 5 mM, 6 mM, 7 mM, 8 mM, 9 mM or 10 mM. In some aspects, the elicitor in a ready-to-apply composition is between about 1-2 mM, between about 2-3 mM, between about 3-4 mM, between about 4-5 mM, between about 5-6 mM, between about 6-7 mM, between about 7-8 mM, between about 8-9 mM, or between about 9-10 mM.

The compositions disclosed herein include liquid and/or dry forms and include dry stock components that are added to water or other liquids prior to application to the plant in an aqueous form. Liquid compositions include aqueous, polar, or non-polar solutions. The compositions may comprise an oil-in-water emulsion or a water-in-oil emulsion. In some embodiments, the composition is diluted. In some embodiments the composition is concentrated. In some embodiments the composition is aqueous.

The effect on plants of the disclosed methods and compositions can be observed both genetically and chemically by any or all of the well-known analysis techniques including genomics, transcriptomics, proteomics, and metabolomics. The effect of different treatments on primary and secondary metabolite production can influence the taste, smell, appearance, effect, quality, yield, stress tolerance, and/or productivity of the living plant and its harvestable plant parts.

In some embodiments, the compositions disclosed herein may be mixed with one or more auxiliaries, adjuvants, excipients, surfactants, or other chemicals. Jasmonates and salicylates may be applied simultaneously but separately from plant growth inputs, like nutrients and pesticides, for improved performance or facility. In some embodiments, jasmonate compounds including but not limited to MeJA, MDJ, and CJ are used independently or as a mixture and applied in conjunction with antagonistic compounds including, but not limited to salicylates, like Methyl Salicylate (MS) and SA. A jasmonate may be applied at the same time, or at a different time than the antagonistic compound, in order to elicit distinct metabolomic responses from the plant.

### Biologicals

In some embodiments, the disclosure provides for compositions and methods of using both biological (e.g., microbial) and biochemical (jasmonate) applications targeted toward pests and pathogens. In some embodiments, the jasmonate or composition comprising a jasmonate is applied in combination with one or more biologicals.

Biologicals are products that are created from, or derived from, living organisms, plant extracts, beneficial insects, or other organic matter. Additional names in the art include, for example, bioeffector, biocontrol agent, bioherbicide, bioactivity, biorational insecticide, and biodigester.

In recent years they have become a valuable tool in sustainable agriculture. Induced Systemic Resistance (ISR) is a phenomenon characterized by soil-inhabiting rhizobacteria repressing soil-borne, necrotrophic pathogens. ISR is the emergence of plant-wide pest resistance triggered from an abiotic stress, such as plant interaction with a biological. Thus in some embodiments, contacting a biological to a plant may cause the plant to develop resistance to one or more pests. In some embodiments, the biological itself also exhibits pest control properties. Numerous pathogens are also susceptible to jasmonate-mediated defense (Glazebrook, J. Contrasting Mechanisms of Defense Against Biotrophic and Necrotrophic Pathogens, Ann. Rev. of Phytopathology (2005) 43:205-227). Therefore, in some embodiments, by reinforcing jasmonate mediated defenses through ISR elicitation, biologicals comprising beneficial bacteria enhance biocontrol.

In some embodiments, a biological comprised by a composition herein, or employed in a method herein, comprises a biostimulant, a biopesticide, or a biofertilizer. In some embodiments, a biological herein is a composition comprising microbes. In some embodiments, a biological herein comprises a rhizobacterium. In some embodiments, the biological comprises a Bacillus sp. In some embodiments, the biological comprises Azospirillum sp. In some embodiments, the biological comprises Pantoea sp. In some embodiments, a biological herein comprises an Agrobiotech product from Probelte®. In some embodiments, a biological herein comprises a product from Impello®.

In some embodiments, a biological herein is a composition comprising microbes. In some embodiments, a biological herein is a product listed in Table 1. In some embodiments, a biological herein comprises a bacterial strain listed in Table 1.

TABLE 1
Illustrative biological products and bacterial strains.

| Product | Strains |
|---|---|
| Impello ® Tribus ® | Bacillus subtilis strain Itri1 |
| | Bacillus pumilus strain Itri2 |
| | Bacillus amyloliquefaciens strain Itri3 |
| Impello ® Continuum ™ | Paenibacillus chitinolyticus strain |
| | Icon1, |
| | Bacillus subtilis strain Icon2 |
| | Bacillus pumilus strain Icon3 |
| | Bacillus amyloliquefaciens strain Icon4 |
| Probelte ® Biopron ™ or | Azospirillum brasilense strain Pbio1 |
| Biopron ™ Premium | Pantoea dispersa strain Pbio2 |
| Probelte ® Bøtrybël ™ | Bacillus amyloliquefaciens strain Pbot1 |
| Probelte ® Bulhnova ™ | Azospirillum brasilense strain Pbul1 |
| | Pantoea dispersa strain Pbul2 |
| Probelte ® Nemapron ™ | Azospirillum sp. strain Pnem1 |
| | Bacillus spp. strain Pnem2 |
| Probelte ® Strongest ™ | Azospirillum brasilense strain Pstr1 |
| Probelte ® Belthirul ™ | Bacillus thuringiensis var. kurstaki |
| | strain Pbel1 |
| Probelte ® Belthirul ™ F | Bacillus thuringiensis var. kurstaki |
| | strain Pbel1F |
| Probelte ® Belthirul ™ S | Bacillus thuringiensis var. kurstaki |
| | strain Pbel1S |
| Probelte ® Belthirul ™ 16 SC | Bacillus thuringiensis var. kurstaki |
| | strain Pbel116SC |
| Probelte ® Lepiback ™ | Bacillus thuringiensis var. kurstaki |
| | strain Plep1 |

In some embodiments, a biological herein comprises any of the species or strains listed in Table 1. In some embodiments, the biological comprises about 10⁴, 10⁵, 10⁶, 10⁷, 10⁸, 10⁹, or 10¹⁰ CFU/mL of a microbe listed herein. In some embodiments, the biological comprises about 10⁷, 10⁸, 10⁹, or 10¹⁰ CFU/g of a microbe listed herein.

### Biostimulants

In some embodiments, the biological comprises a biostimulant. Biostimulants are substances or microorganisms that, when applied to seeds, plants, or the rhizosphere, stimulate natural processes within the plant or the plant microbiome (including the entirety of the phytomicrombiome, e.g. the phyllosphere and rhizosphere) to enhance or benefit nutrient uptake, nutrient efficiency, tolerance to abiotic stress, or crop quality and yield. In some embodiments, the biological is a biostimulant. In some embodiments, the biostimulant comprises humic substances, hormones, cell signaling molecules, seaweed extract, and/or amino acids.

In some embodiments, the biological is selected from auxins, cytokinins, gibberellins, abscisic acid, ethylene, brassinosteroids, jasmonic acid, strigolactones, chemical mimics of strigolactone, and combinations thereof.

In some embodiments, the biostimulant comprises a strigolactone or chemical mimics of strigolactone. Such compounds are described in PCT/US2016/029080, filed Apr. 23, 2016, and entitled: Methods for Hydraulic Enhancement of Crops, and US2021/0329917, published Oct. 28, 2021 and entitled: Compounds and Methods for Increasing Soil Nutrient Availability, which are hereby incorporated by reference. They are further described in U.S. Pat. No. 9,994,557, issued on Jun. 12, 2018, and entitled: Strigolactone Formulations and Uses Thereof, which is hereby incorporated by reference.

### Biopesticides

In some embodiments, the biological comprises a biopesticide. Biopesticides include any naturally occurring substance that controls pests, known as biochemical pesticides, microorganisms that control pests, known as microbial pesticides, and pesticidal substances produced by plants containing added genetic material-known as plant-incorporated protectants or PIPs. Biopesticides can also include semiochemicals, peptides, proteins and nucleic acids such as double-stranded DNA, single-stranded DNA, double-stranded RNA, single-stranded RNA and hairpin DNA or RNA. In some embodiments, the biological is a biopesticide disclosed in Table 2.

TABLE 2
Examples of Biopesticides

| Source | Type | Organism | Pest Type |
|---|---|---|---|
| Bacteria | Insecticide | Bacillus thuringiensis | caterpillars, fungi |
| | | var kurstaki | (Botrytis) Elm Leaf |
| | | B. thuringiensis var | Beetle, Alfalfa |
| | | tenebrionis | weevil |
| | Fungicide | Bacillus subtilis | Botrytis spp |
| Fungi | Insecticide | Beauveria bassiana | Whitefly |
| | Fungicide | Coniothyrium minitans | Sclerotinia spp. |
| | | Trichoderma harzianum | S sclerotiorum |
| | Herbicide | Chondrostereum | cut stumps of |
| | | purpureum | hardwood trees and |
| | | | shrubs |
| | Nematicide | Paecilomyces lilacinus | plant-parasitic |
| | | | nematodes in soil |
| Virus | Insecticide | Cydia pomonella | codling moth |
| | | granulovirus | |
| Oomycetes | Herbicide | Phytophthora palmivora | Morenia orderata |
| Neem (Azadirachta | Insecticide | Azadirachtin | aphids, scale, thrips, |
| indica) | | | whitefly, |
| | | | leafhoppers, weevils |
| Plant extracts | Fungicide | Reynoutria sachalinensis | powdery mildew, |
| | | (giant knotweed) extract | downy mildew, |
| | | | Botrytis, late blight, |
| | | | citrus canker |
| | Herbicide | Plant essential oils | Ragwort, many |
| | | | arthropods |
| | Nematicide | Quillaja saponaria | plant parasitic |
| | | | nematodes |
| Talaromyces flavus; | Biopesticides | | Glomerella |
| Clitoria ternatea | | | cingulata and |
| (butterfly pea); | | | Colletotrichum |
| Trichoderma | | | acutatum; |
| harzianum; Bacillus | | | Helicoverpa spp.; |
| thuringiensis var. | | | Fusarium |
| tenebrionis; | | | oxysporum |
| Lactobacillus casei | | | Agelastica alni; |
| fermentation | | | Spodoptera litura, |
| products | | | Helicoverpa |
| | | | armigera, Aphis |
| | | | gossypii; |
| | | | Xanthomonas |
| | | | fragariae; |
| | | | Spodoptera littoralis |
| | | | and others |
| Semiochemical | Attractant | Citronellol | tetranychid mites |
| | | Multi-component sex | codling moth |
| | | pheromone, such as | |
| | | (E,E)-8,10- dodecadien- | |
| | | 1-ol | |
| Arbuscular | Filamentous | Nostoc piscinale; | |
| Mycorrhizal Fungi | cyanobacterium; | Chlamydopodium | |
| | Single-celled | fusiforme; Chlorella | |
| | green algae | vulgaris | |
| | | Anabaena laxa and | Increase in |
| | | Calothrix elenkinii | fungicidal activity |
| Nanobiopesticide | Silver | | Alternaria alternata, |
| | nanobiopesticide | | A. solani |
| | Sargassum | | Ariadne merione, a |
| | muticum | | Lepidopteran pest |
| | derived NPs | | |
| | Caulerpa | | Culex |
| | scalpelliformis | | quinquefasciatus |
| | and | | |
| | Mesocyclops | | |
| | longisetus- | | |
| | derived NPs | | |

In some embodiments, the biological is a biochemical pesticide. Biochemical pesticides control pests by non-toxic mechanisms, such as insect sex pheromones that interfere with mating, and plant extracts that attract an insect pest to a trap or repel an insect pest. Examples of plant extracts used as biochemical pesticides are neem and lemongrass oil. A biochemical pesticide may also be an insect growth regulator, and inhibit processes required for survival of the insect.

Plants produce a wide variety of secondary metabolites that deter herbivores from feeding on them. Some of these can be used as biopesticides. They include, for example, pyrethrins, which are fast-acting insecticidal compounds produced by Chrysanthemum cinerariaefolium. They have low mammalian toxicity but degrade rapidly after application. This short persistence prompted the development of synthetic pyrethrins (pyrethroids). The most widely used botanical compound is neem oil, an insecticidal chemical extracted from seeds of Azadirachta indica. Two highly active pesticides are available based on secondary metabolites synthesized by soil actinomycetes, but they have been evaluated by regulatory authorities as if they were synthetic chemical pesticides. Spinosad is a mixture of two macrolide compounds from Saccharopolyspora spinosa. It has a very low mammalian toxicity and residues degrade rapidly in the field. Farmers and growers used it widely following its introduction in 1997 but resistance has already developed in some important pests such as western flower thrips. Abamectin is a macrocyclic lactone compound produced by Streptomyces avermitilis. It is active against a range of pest species but resistance has developed to it also, for example, in tetranychid mites.

Peptides and proteins from a number of organisms have been found to possess pesticidal properties. Perhaps most prominent are peptides from spider venom (King, G. F. and Hardy, M. C. (2013) Spider-venom peptides: structure, pharmacology, and potential for control of insect pests. Annu. Rev. Entomol. 58:475-496). A unique arrangement of disulfide bonds in spider venom peptides render them extremely resistant to proteases. As a result, these peptides are highly stable in the insect gut and hemolymph and many of them are orally active. The peptides target a wide range of receptors and ion channels in the insect nervous system. Other examples of insecticidal peptides include: sea anemone venom that act on voltage-gated Na+ channels (Bosmans, F. and Tytgat, J. (2007) Sea anemone venom as a source of insecticidal peptides acting on voltage-gated Na+ channels. Toxicon. 49 (4): 550-560); the PA1b (Pea Albumin 1, subunit b) peptide from Legume seeds with lethal activity on several insect pests, such as mosquitoes, some aphids and cereal weevils (Eyraud, V. et al. (2013) Expression and Biological Activity of the Cystine Knot Bioinsecticide PA1b (Pea Albumin 1 Subunit b). PLOS ONE 8 (12); e81619); and an internal 10 kDa peptide generated by enzymatic hydrolysis of Canavalia ensiformis (jack bean) urease within susceptible insects (Martinelli, A. H. S., et al. (2014) Structure-function studies on jaburetox, a recombinant insecticidal peptide derived from jack bean (Canavalia ensiformis) urease. Biochimica et Biophysica Acta 1840:935-944). Examples of commercially available peptide insecticides include Spear™-T for the treatment of thrips in vegetables and ornamentals in greenhouses, Spear™—P to control the Colorado Potato Beetle, and Spear™—C to protect crops from lepidopteran pests (Vestaron Corporation, Kalamazoo, MI). A novel insecticidal protein from Bacillus bombysepticus, called parasporal crystal toxin (PC), shows oral pathogenic activity and lethality towards silkworms and Cry1 Ac-resistant Helicoverpa armigera strains (Lin, P. et al. (2015) PC, a novel oral insecticidal toxin from Bacillus bombysepticus involved in host lethality via APN and BIR-175. Sci. Rep. 5:11101).

A semiochemical is a chemical signal produced by one organism that causes a behavioral change in an individual of the same or a different species. The most widely used semiochemicals for crop protection are insect sex pheromones, some of which can now be synthesized and are used for monitoring or pest control by mass trapping, lure-and-kill systems and mating disruption. Worldwide, mating disruption is used on over 660,000 ha and has been particularly useful in orchard crops.

In some embodiments, the biological is a microbial pesticide. Microbial pesticides comprise a microorganism as the active ingredient. The microorganism may be a bacterium, fungus, virus, or protozoan.

An example microbial pesticide are some species and strains of Bacillus thuringiensis (Bt), which can control for example, moths, flies, and mosquitoes. Other microbial pesticides may be obtained from species of Bacillus, Pseudomonas, Yersinia, Chromobacterium, Beauveria, Metarhizium, Verticillium, Lecanicillium, Hirsutella, Paecilomyces, baculoviruses, arbuscular mycorrhizal fungi, Heterorhabditis, and Steinernema. In some embodiments, the microbial pesticide is derived from Bacillus thuringiensis.

The most widely used microbial biopesticide is the insect pathogenic bacteria Bacillus thuringiensis (Bt), which produces a protein crystal (the Bt 8-endotoxin) during bacterial spore formation that is capable of causing lysis of gut cells when consumed by susceptible insects. Microbial Bt biopesticides consist of bacterial spores and 8-endotoxin crystals mass-produced in fermentation tanks and formulated as a sprayable product. Bt does not harm vertebrates and is safe to people, beneficial organisms and the environment. Thus, Bt sprays are a growing tactic for pest management on fruit and vegetable crops where their high level of selectivity and safety are considered desirable, and where resistance to synthetic chemical insecticides is a problem. Bt sprays have also been used on commodity crops such as maize, soybean and cotton, but with the advent of genetic modification of plants, farmers are increasingly growing Bt transgenic crop varieties.

Other microbial insecticides include products based on entomopathogenic baculoviruses. Baculoviruses that are pathogenic to arthropods belong to the virus family and possess large circular, covalently closed, and double-stranded DNA genomes that are packaged into nucleocapsids. More than 700 baculoviruses have been identified from insects of the orders Lepidoptera, Hymenoptera, and Diptera. Baculoviruses are usually highly specific to their host insects and thus, are safe to the environment, humans, other plants, and beneficial organisms. Over 50 baculovirus products have been used to control different insect pests worldwide. In the US and Europe, the Cydia pomonella granulovirus (CpGV) is used as an inundative biopesticide against codlingmoth on apples. Washington State, as the biggest apple producer in the US, uses CpGV on 13% of the apple crop. In Brazil, the nucleopolyhedrovirus of the soybean caterpillar Anticarsia gemmatalis was used on up to 4 million ha (approximately 35%) of the soybean crop in the mid-1990s. Viruses such as Gemstar® (Certis USA) are available to control larvae of Heliothis and Helicoverpa species.

At least 170 different biopesticide products based on entomopathogenic fungi have been developed for use against at least five insect and acarine orders in glasshouse crops, fruit and field vegetables as well as commodity crops. The majority of products are based on the ascomycetes Beauveria bassiana or Metarhizium anisopliae. M. anisopliae has also been developed for the control of locust and grasshopper pests in Africa and Australia and is recommended by the Food and Agriculture Organization of the United Nations (FAO) for locust management.

A number of microbial pesticides are registered in the United States. See for example Kabaluk et al. 2010 (Kabaluk, J. T. et al. (ed.). 2010. The Use and Regulation of Microbial Pesticides in Representative Jurisdictions Worldwide. IOBC Global. 99pp. Microbial pesticides registered in selected countries are listed in Annex 4 of Hoeschle-Zeledon et al. 2013 (Hoeschle-Zeledon, I, P. Neuenschwander and L. Kumar. (2013). Regulatory Challenges for biological control. SP-IPM Secretariat, International Institute of Tropical Agriculture (IITA), Ibadan, Nigeria. 43 pp.), each of which is incorporated herein in its entirety.

In some embodiments, the biological is a Plant-Incorporated-Protectant (PIP), PIPs are pesticidal substances produced by genetically engineered plants. For example, in some embodiments, a plant is engineered to produce one or more of the pesticidal Cry or VIP proteins from Bacillus thuringiensis.

As used herein, “transgenic insecticidal trait” refers to a trait exhibited by a plant that has been genetically engineered to express a nucleic acid or polypeptide that is detrimental to one or more pests. In one embodiment, the plants of the present disclosure are resistant to attachment and/or infestation from any one or more of the pests of the present disclosure. In one embodiment, the trait comprises the expression of vegetative insecticidal proteins (VIPs) from Bacillus thuringiensis, lectins and proteinase inhibitors from plants, terpenoids, cholesterol oxidases from Streptomyces spp., insect chitinases and fungal chitinolytic enzymes, bacterial insecticidal proteins and early recognition resistance genes. In another embodiment, the trait comprises the expression of a Bacillus thuringiensis protein that is toxic to a pest. In one embodiment, the Bt protein is a Cry protein (crystal protein). Bt crops include Bt corn, Bt cotton and Bt soy. Bt toxins can be from the Cry family (see, for example, Crickmore et al., 1998, Microbiol. Mol. Biol. Rev. 62:807-812), which are particularly effective against Lepidoptera, Coleoptera and Diptera.

Bt Cry and Cyt toxins belong to a class of bacterial toxins known as pore-forming toxins (PFT) that are secreted as water-soluble proteins undergoing conformational changes in order to insert into, or to translocate across, cell membranes of their host. There are two main groups of PFT: (i) the α-helical toxins, in which α-helix regions form the trans-membrane pore, and (ii) the β-barrel toxins, that insert into the membrane by forming a β-barrel composed of Bsheet hairpins from each monomer. See, Parker M W, Feil S C, “Pore-forming protein toxins: from structure to function,” Prog. Biophys. Mol. Biol. 2005 May; 88 (1): 91-142. The first class of PFT includes toxins such as the colicins, exotoxin A, diphtheria toxin and also the Cry three-domain toxins. On the other hand, aerolysin, α-hemolysin, anthrax protective antigen, cholesterol-dependent toxins as the perfringolysin O and the Cyt toxins belong to the β-barrel toxins. Id. In general, PFT producing-bacteria secrete their toxins and these toxins interact with specific receptors located on the host cell surface. In most cases, PFT are activated by host proteases after receptor binding inducing the formation of an oligomeric structure that is insertion competent. Finally, membrane insertion is triggered, in most cases, by a decrease in pH that induces a molten globule state of the protein. Id.

The development of transgenic crops that produce Bt Cry proteins has allowed the substitution of chemical insecticides by environmentally friendly alternatives. In transgenic plants the Cry toxin is produced continuously, protecting the toxin from degradation and making it reachable to chewing and boring insects. Cry protein production in plants has been improved by engineering cry genes with a plant biased codon usage, by removal of putative splicing signal sequences and deletion of the carboxy-terminal region of the protoxin. See, Schuler T H, et al., “Insect-resistant transgenic plants,” Trends Biotechnol. 1998; 16:168-175. The use of insect resistant crops has diminished considerably the use of chemical pesticides in areas where these transgenic crops are planted. See, Qaim M, Zilberman D, “Yield effects of genetically modified crops in developing countries,” Science. 2003 Feb. 7; 299 (5608): 900-2.

In some embodiments, the plant is engineered to express a protein selected from 8-endotoxins including but not limited to: the Cry1, Cry2, Cry3, Cry4, Cry5, Cry6, Cry7, Cry8, Cry9, Cry10, Cry11, Cry12, Cry13, Cry14, Cry15, Cry16, Cry17, Cry18, Cry19, Cry20, Cry21, Cry22, Cry23, Cry24, Cry25, Cry26, Cry27, Cry 28, Cry 29, Cry 30, Cry31, Cry32, Cry33, Cry34, Cry35, Cry36, Cry37, Cry38, Cry39, Cry40, Cry41, Cry42, Cry43, Cry44, Cry45, Cry 46, Cry47, Cry49, Cry 51, Cry52, Cry 53, Cry 54, Cry55, Cry56, Cry57, Cry58, Cry59. Cry60, Cry61, Cry62, Cry63, Cry64, Cry65, Cry66, Cry67, Cry68, Cry69, Cry70 and Cry71 classes of δ-endotoxin genes and the B. thuringiensis cytolytic cyt1 and cyt2 genes.

### Biofertilizers

In some embodiments, the biological comprises a biofertilizer Biofertilizers are microorganisms, such as bacteria, fungi, and algae, that provide plants with nutrients, or help them to absorb nutrients, thus improving plant yield. Types of biofertilizers include, but are not limited to, microbes that increase nitrogen fixation, microbes that increase phosphate solubilization, microbes that increase nutrient mobilization, plant growth-promoting microbes, and plant growth-regulating microbes.

In some embodiments, the biological is a biofertilizer selected from the group consisting of a bacterial, algal, and fungal biofertilizer. In some embodiments, the biological is a biofertilizer that comprises at least one of a nitrogen fixer, a phosphate solubilizer, a nutrient mobilizer, plant growth-promoting bacteria, and plant growth-regulating bacteria.

In some embodiments, the biological comprises one or more species of cultured microbe selected from Methylobacterium, mycorrhizal fungi, Gluconacetobacter, Achromobacter, Agrobacterium, Anabaena, Azorhizobium, Azospirillum, Azotobacter, Bacillus, Beauveria, Bradyrhizobium, Clostridium, Enterobacter, Klebsiella, Kluyvera, Kosakonia, Mesorhizobium, Microbacterium, Ochrobactrum, Pantoea, Penicillium, Pseudomonas, Rahnella, Rhizoctonia, Rhizobium, Rhodopseudomonas, Sinorhizobium, Trichoderma, and combinations thereof.

In some embodiments, the biological comprises plant growth-promoting fungi and/or plant growth-promoting bacteria.

### Plant Growth-Promoting Fungi (PGPF)

PGPF species are beneficial to plants in several ways. For example, they can solubilize and mineralize nutrients making them accessible to plants; they regulate hormones; they produce compounds that suppress plant pathogens and alleviate abiotic stressors. In some embodiments, the biological comprises PGPF species of the genera Aspergillus, Penicillium, Phoma, Fusarium, Trichoderma, Piriforma, and Glomus.

### Aspergillus

In some embodiments, the biological comprises an Aspergillus species. Species of the fungi Aspergillus can protect plants and promote plant growth via production of pytases, auxins, gibberellins, and many secondary metabolites. The phytases for example, aid in phosphate solubilization. Some species of Aspergillus also are antagonist to plant pathogens (see for example, Nayak S. et al., (2020). Beneficial Role of Aspergillus sp. in Agricultural Soil and Environment, Frontiers in Soil and Environmental Microbiology (pp. 17-36)). Species of Aspergillus that have plant beneficial activity that may be included with the compositions, methods, kits, and systems disclosed herein. In some embodiments, the biological comprises a species of Aspergillus selected from, but not limited to, A. aculeatus, A. brasiliensis, A. clavatus, A. flavus, A. fumigatus, A. mellus, A. niger, A. nidulans, A. oryzae, A. sydowii, A. terreus, A. tubingensis, A. ustus, and A. sp. versicolor.

### Penicillium

In some embodiments, the biological comprises a Penicillium species. Many species of Penicillium have positive interactions with plants and can promote plant growth by supplying soluble phosphorus, indole-3-acetic acid, and gibberellic acid, and can also provide protection by acting as an antagonist to pathogens and/or activating plant defense signaling, and tolerance to abiotic stressors related to temperature, heavy metals, salt, and water. In some embodiments, the biological comprises a species of Penicillium selected from, but not limited to, P. bilaiae. P. brevicompactum, P. brocae, P. canescens, P. cecidicola, P. citrinum, P. coffeae, P. commune, P. crustosum, P. funiculosum, P. janthinellum, P. monteilii, P. olsonii, P. oxalicum, P. radicum, P. ruqueforti, P. sclerotiorum, P. simplicissimum, and P. steckii

### Trichoderma

In some embodiments, the biological comprises a Trichoderma species. Species of Trichoderma are present in soils all over the world. They have been shown to form mutualistic relationships with several plant species, regulating the rate of plant growth and suppressing the growth of plant pathogens through competition, antibiotic production, and chitinase secretion. The fungi further secrets organic acids that solubilize phosphates and mineral ions, such as iron, magnesium, and manganese. In some embodiments, the biological comprises a species of Trichoderma selected from, but not limited to, T. harzianum, T. atroviride, T. asperellum, T. virens, T. longipile, T. tomentosum, T. viride, T. afroharzianum, and T. hamatum.

### Mycorrhizal Fungi and Glomus

In some embodiments, the biological comprises a mycorrhizal fungi. Mycorrhizal fungi enhance plant access to soil nutrients and water. There are two functional types, arbuscular mycorrhizal fungi (AMF) and ectomycorrhizal fungi (EMF) which partner with plants having different nutrient acquisition strategies (for example, fast N cycling vs. slow N cycling). An example genus of AMF is Glomus. In some embodiments, the biological is a mycorrhizal fungi selected from Glomus intraradices, Glomus mosseae, Glomus aggregatum, Glomus etunicatum, Glomus clarus, and Rhizophagus intraradices.

### Plant Growth-Promoting Rhizobacteria (PGPR)

In some embodiments, the biological comprises a PGPR. PGPR species promote plant growth via direct mechanisms (for example, by improving nutrient acquisition and regulating phytohormones) and indirect mechanisms (for example, by inducing resistance to stressors of competing with a pathogen). In some embodiments, the biological comprises a PGPR species selected from the genera of Acinetobacter, Aeromonas, Agrobacterium, Allorhizobium, Arthrobacter, Azoarcus, Azorhizobium, Azospirillum, Azotobacter, Bacillus, Bradyrhizobium, Burkholderia, Caulobacter, Chromobacterium, Delftia, Enterobacter, Flavobacterium, Frankia, Gluconacetobacter, Klebsiella, Mesorhizobium, Methylobacterium, Micrococcus, Paenibacillus, Pantoea, Pseudomonas, Rhizobium, Serratia, Streptomyces, and Thiobacillus.

### Azospirillum

In some embodiments, the biological comprises an Azospirillum species. Azospirillum species have been shown to increase the yield, drought tolerance, and salt tolerance of crops such as corn, wheat, rice, and sugarcane (see for example G. F. Vogel, et al., Agronomic performance of Azospirillum brasilense on wheat crops, Appl. Res. Agrotechnol., 6 (2013), pp. 111-119; J. E. Garcia, et al., In vitro PGPR properties and osmotic tolerance of different Azospirillum native strains and their effects on growth of maize under drought stress, Microbiological Research 202 (2017) pp 21-29). Axospirillum further promotes plant growth through production of auxins, cytokinins, and gibberellins. In some embodiments, the biological comprises a species of Azospirillum selected from A. brasilense, A. amazonense, A. irakense, A. lipoferum, A. largimobile, A. halopraeferens, A. oryzae, A. canadensis, A. doebereinerae, and A. melinis

### Pseudomonas

In some embodiments, the biological comprises a Pseudomonas species. Pseudomonas species are present in both the rhizosphere as well as the within plant tissues. They have been extensively studied for their roles in plant growth promotion, control of pests and pathogens, and nutrient solubilization (Kumar A., et al., Role of Pseudomonas sp. in Sustainable Agriculture and Disease Management, (2017) pp 195-215). In some embodiments, the biological comprises a species of Pseudomonas selected from P. aeruginosa, P. aureofaciens, P. cepacia (formerly known as Burkholderia cepacia), P. chlororaphis, P. corrugata, P. fluorescens, P. proradix, P. putida, P. rhodesiae, P. syringae, P. protegens, P. chlororaphis, P. segetis, and P. segetis strain P6.

### Bacillus

In some embodiments, the biological comprises a Bacillus species. Bacillus is a diverse group of bacteria in the soil ecosystem, playing roles in nutrient cycling and imparting plant beneficial traits such as stress tolerance (see for example A. K. Saxena et al., “Bacillus species in soil as a natural resource for plant health and nutrition.” 2019. J of App. Microbiology, 128 (5): 1583-1594). In some embodiments, the biological comprises a species of Bacillus selected from B. subtilis, B. velezensis, B. siamensis, B. cereus, B. thuringiensis, Bacillus thuringiensis (var. kurstaki), B. thuringiensis subsp. israelensis, B. thuringiensis subsp. tenebrionis strain SA-10, B. thuringiensis subsp. aizawai, Bacillus thuringiensis strain VBTS 2528, B. licheniformis, B. pumilus, Bacillus pumilus strain QST 2808, B. altitudinis, B. stratosphericus, B. aerius, B. safensis, B. australimaris, B. amyloliquefaciens, B. methylotrophicus, B. megaterium, B. simplex, B. sp. AQ175 (ATCC Accession No. 55608), B. sp. AQ 177 (ATCC Accession No. 55609), B. sp. AQ178 (ATCC Accession No. 53522), B. sphaericus, B. bombysepticus, B. firmus, B. coagulans, B. azotofixans, and B. macerans.

In some embodiments, the biological comprises a soil inoculant comprising Bacillus sp. In some embodiments, the soil inoculant comprises species of Bacillus. In some embodiments, the biological comprises B. subtilis, B. pumilus, B. amyloliquefaciens, B. licheniformis, Paenibacillus chitinolyticus and/or B. laterosporus.

### Methylobacterium

In some embodiments, the biological comprises a Methylobacterium species. Methylobacterium are a genus of non-pathogenic bacteria found in a wide range of environments. A number of species of Methylobacterium have been shown to promote plant growth through their production of plant hormones such as cytokinins, abscisic acid, and indole-3-acetic acid. Of note, they are able to produce high levels of cytokinins and the active trans-Zeatin form (see for example, Palberg, D., et al. A survey of Methylobacterium species and strains reveals widespread production and varying profiles of cytokinin phytohormones. BMC Microbiol 22, 49 (2022)). In some embodiments, the biological comprises a species of Methylobacterium selected from M. gregans, M. adhaesivum, M. aerolatum, M. ajmalii, M. aquaticum, M. aminovorans, M. brachiatum, M. brachythecii, M. bullatum, M. cerastii, M. crusticola, M. currus, M. dankookense, M. durans, M. extorquens, M. frigidaeris, M. fujisawaense, M. funariae, M. gnaphalii, M. goesingense, M. gossipicola, M. haplocladii, M. hispanicum, M. indicum, M. iners, M. isbiliense, M. jeotgali, M. komagatae, M. longum, M. marchantiae, M. mesophylicum, M. nodulans, M. nonmethylotrophicum, M. organophillum, M. oryzae, M. oryzihabitans, M. oxalidis, M. persicinum, M. phyllosphaerae, M. phyllostachyos, M. planium, M. platani, M. pseudosasicola, M. radiotolerans corrig., M. rhodinum, M. segetis, M. soli, M. symbioticum, M. tardum, M. tarhaniae, M. terrae, M. terricola, M. thuringiense, M. trifolii, M. thiyocyanatum, M. variabile, M. zatmanii.

### Gluconacetobacter

In some embodiments, the biological comprises a Gluconacetobacter species. Species of Gluconacetobacter can establish symbiotic relationships with plants and promote growth and nitrogen fixation. In some embodiments, the biological comprises a species of Gluconacetobacter selected from G. azotocaptans, G. diazotrophicus, G. johannae, and G. sacchari

### Pantoea

In some embodiments, the biological comprises a Pantoea sp. In some embodiments, the biological comprises a species of Pantoea selected from Pantoea agglomerans, Pantoea agglomerans strain C9-1, Pantoea agglomerans strains (ATCC 27155, CCUG 539, CDC 1461-67, CFBP 3845, CIP 57.51, DSM 3493, ICPB 3435, ICMP 12534, JCM 1236, LMG 1286, NCTC 9381), Pantoea allii, Pantoea ananatis, Pantoea anthophila, Pantoea citrea, Pantoea deleyi, Pantoea dispersa, Pantoea eucalypti, Pantoea punctata, Pantoea stewartii, Pantoea terrea, and Pantoea vagans.

### Probelte® Biologicals

In some embodiments, the biological is a product from Probelte®. In some embodiments, the biological is an Agrobiotech product from Probelte®. In some embodiments, the biological is Biopron™ Premium, Bøtrybel™, Bulhnova™, Nemapron™, Strongest™, Belthirul™, Belthirul™ F, Belthirul™ S, Belthirul™ 16 SC, or Lepiback™. In some embodiments, the biological is a product listed in the product catalog of Probelte®, which can be retrieved from the world wide web at: probelte.com/wp-content/uploads/2022/02/Probelte_Product_catalogue.pdf. In some embodiments, the biological is Bøtrybël™. In some embodiments, the biological comprises Bacillus amyloliquefaciens. In some embodiments, the biological comprises 108 CFU/mL Bacillus amyloliquefaciens. In some embodiments, the biological is for administration at a dose of 12-15 cc/L as a foliar application every 7-14 days. In some embodiments, the biological is for administration at 5-15 L/ha, 1-5 times. For example, in some embodiments, the biological is for administration 5-7 days after transplanting, 30-40 days after first application, and 50-60 days after first application.

In some embodiments, the biological is a Probelte® product, and it is administered in conjunction with a jasmonate disclosed herein, and it is for administration at the recommended dose according to its product packaging or labeling. In some embodiments, the Probelte® product is administered separately from a jasmonate composition disclosed herein. In some embodiments, the Probelte® product is administered in combination with a jasmonate composition disclosed herein.

In some embodiments, the biological is a composition or microbial strain disclosed in any one of WO-2008113873-A1, WO-2009013596-A2, WO-2009031023-A2, WO-2011036316-A2, WO-2011121408-A1, WO-2008090460-A1, WO-2009027544-A1, WO-2010041096-A1, or WO-2020216978-A1, each of which is incorporated by reference herein in its entirety.

### Impello® Biologicals

In some embodiments, the biological is an Impello® product. In some embodiments, the biological is a microbial inoculant, biostimulating additive, or nutrient product from Impello®. In some embodiments, the product is Biofuel™, Continuum™, Dune™, Lumina™, Tribus®, or Tundra™. In some embodiments, the product is any of the products available from Impello, a list of which can be retrieved from the world wide web at: impellobio.com/collections/all.

In some embodiments, the biological comprises microbial soil inoculants. In some embodiments, the biological comprises species of B. subtilis, B. pumilus, B. amyloliquefaciens, B. licheniformis, Paenibacillus chitinolyticus and/or B. laterosporus. In some embodiments, the biological comprises species of B. subtilis, B. pumilus, B. amyloliquefaciens, and/or Paenibacillus chitinolyticus. In some embodiments, the biological comprises a commercially available soil inoculant. in some embodiments, the biological comprises Tribus® or Continuum™. In some embodiments, the biological comprises Bacillus subtillis (e.g., at about 4.0×10⁹ CFU/ml), Bacillus pumilus (e.g., at about 4.0×10⁹ CFU/ml), and Bacillus amyloliquefaciens (e.g., at about 2.0×10⁹ CFU/ml). In some embodiments, the biological comprises Paenibacillus chitinolyticus (e.g., at about 10⁶ CFU/mL), Bacillus subtillis (e.g., at about 10⁶ CFU/mL), Bacillus pumilus (e.g., at about 10⁶ CFU/mL), and Bacillus amyloliquefaciens (e.g., at about 10⁶ CFU/mL).

### Methods of Application

In some embodiments, the methods and compositions disclosed herein can be applied to seed, seedling, clone stock, vegetative tissues, root tissues, leaves, flowering tissues, and mature plant parts. The elicitor or composition comprising an elicitor may be applied in liquid or dry form, using a foliar spray, a root drench or a gas to subterranean plant cells and/or aerial plant cells. The elicitor or composition comprising an elicitor may be applied to the soil, to the plant, or to both the soil and the plant. The elicitor or composition comprising an elicitor may be applied to plant parts using methods known in the art, such as foliar spray, atomization, fumigation, or chemigation. The elicitor or composition comprising an elicitor may be applied to the soil using methods known in the art such as irrigation, chemigation, fertigation, or injection. The elicitor or composition comprising an elicitor may be applied to a soil or a water or a carbon dioxide or a fertilizer source, including hydroponic and aeroponic and carbon dioxide injection systems, which is delivered to the plant in a liquid, dry, or gaseous form. In some embodiments, the plant may be grown indoors or outdoors, in a controlled or uncontrolled environment, in fields or in containers. The plant may be grown in soil-based media, soil-less media, or a media containing both soil-less and soil-based components. The plant may be grown in coco, rockwool, peat moss, or other acceptable medias well-known in the art. The plant may be grown with organic (Carbon-based), inorganic (synthetic), or a combination of both, fertilizers, amendments, adjuvants, pesticides, and supplements.

In some embodiments the elicitor or composition comprising an elicitor is applied to immature plants, seeds, or seedlings. In some embodiments, the elicitor or composition comprising an elicitor is applied to mature plants and/or plants in the reproductive stages. In some embodiments, the elicitor or composition comprising an elicitor is applied before harvest. In some embodiments, the elicitor or composition comprising an elicitor is applied between 24 and 72 hours before harvest. When the elicitor or composition comprising an elicitor is applied to growing plant parts or flowers, the same, or a different composition may be applied at a later stage of growth, or before harvest.

In some embodiments, an elicitor or composition comprising an elicitor are used independently or as a mixture to alter the production of valuable primary and/or secondary metabolites by contacting some part of the plant or its environment at one or more distinct timepoints throughout the plant's lifecycle. One or more elicitors may be applied once or more about: every day, every 2 days, every 3 days, every 4 days, every 5 days, every 6 days, every 7 days, every 5 days, every 9 days, every 10 days, every 11 days, every 12 days, every 13 days, every 14 days, every 15 days, every 16 days, every 17 days, every 18 days, every 19 days, every 20 days, every 21 days, every 22 days, every 23 days, every 24 days, every 25 days, every 26 days, every 27 days, every 28 days, every 29 days, every 30 days, every 31 days, every 32 days, every 33 days, every 34 days, every 35 days, every 36 days, every 37 days, every 38 days, every 39 days, every 40 days, every 41 days, every 42 days, every 43 days, every 44 days, every 45 days, every 46 days, every 47 days, every 48 days, every 49 days, every 50 days, every 51 days, every 52 days, every 53 days, every 54 days, every 55 days, every 56 days, every 57 days, every 58 days, every 59 days, every 60 days, every 61 days, every 62 days, every 63 days, every 64 days, every 65 days, every 66 days, every 67 days, every 68 days, every 69 days, every 70 days, every 71 days, every 72 days, every 73 days, every 74 days, every 75 days, every 76 days, every 77 days, every 78 days, every 79 days, every 80 days, every 81 days, every 82 days, every 83 days, every 84 days, every 85 days, every 86 days, every 87 days, every 88 days, every 89 days, every 90 days, every 91 days, every 92 days, every 93 days, every 94 days, every 95 days, every 96 days, every 97 days, every 98 days, every 99 days, every 100 days, every 101 days, every 102 days, every 103 days, every 104 days, every 105 days, every 106 days, every 107 days, every 108 days, every 109 days, every 110 days, or any combination of those days.

In some embodiments, one or more elicitors may be applied only once during the entire plant life cycle. In some embodiments, one or more elicitors may be applied more than once during the plant life cycle.

In some embodiments, the elicitor is applied to rhizomes. In some embodiments, the elicitor is applied at emergence. In some embodiments, the elicitor is applied when the first pair of side shoots is visible. In some embodiments, the elicitor is applied during the vegetative growth phase. In some embodiments, the elicitor is applied during the flowering phase. In some embodiments, the elicitor is applied prior to flowering. In some embodiments, the elicitor is applied at or after flowering. In some embodiments, the elicitor is applied prior to cone formation. In some embodiments, the elicitor is applied after cone formation. In some embodiments, the elicitor is applied to the cones. In some embodiments, the elicitor is applied before stripping. In some embodiments, the elicitor is applied between 72 and 24 hours prior to harvest.

In some embodiments, the elicitor is applied every 3 to 10 days. In some embodiments, the elicitor is applied once a week. In some embodiments, the elicitor is applied once every two weeks.

In some embodiments, the elicitor is applied as a foliar spray or root drench.

In some embodiments, the effective amount for hop is calculated for an application rate of 100 gallons per acre. In some embodiments, the effective amount for hop is between 850-1700 ppm applied at an application rate of 100 gallons per acre. In some embodiments, the effective amount is calculated for delivery via foliar spray. In some embodiments, the foliar spray is applied until dripping.

In some embodiments, the effective amount of the elicitor is between 0.1 mM and 10 mM. In some embodiments, the effective amount of the elicitor is between 0.1 and 1 mM. In some embodiments, the effective amount of the elicitor is between 1 and 5 mM. In some embodiments, the effective amount of the elicitor is between 5 and 10 mM. In some embodiments, the effective amount of the elicitor is about 0.1, 0.2, 0.3, 0.4, 0.5, 0.6, 0.7, 0.8, 0.9 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mM, including all values and sub-ranges therebetween. In some embodiments, the effective amount of the elicitor is about 1 mM. In some embodiments, the effective amount of the elicitor is about 2.5 mM. In some embodiments, the effective amount of the elicitor is about 5 mM. In some embodiments, the effective amount of the elicitor is about 7.5 mM. In some embodiments, the effective amount of the elicitor is about 10 mM.

### EXAMPLES

### Example 1: Application of MDJ Alters Hop Terpene Content and Ratios

### Materials and Methods

Hop plants were treated with illustrative elicitor compositions of the disclosure to determine the effect of treatment on hop terpene content. The hop cultivar was Cashmere Hops. The treatments were as follows: A, 1 mM methyl dihydrojasmonate (“MDJ”); B, 1 mM methyl salicylate (“MS”); C 2 mM MS+MSJ (1 mM each of MS and MDJ, total 2 mM applied); D, 5 mM MDJ; and E, Control.

After harvest, treated and control hops were analyzed for terpene content. Terpene analysis was performed according to Analytica EBC Method 7.12, employing Capillary Gas Chromatography with Flame Ionization Detection (FID).

### Results

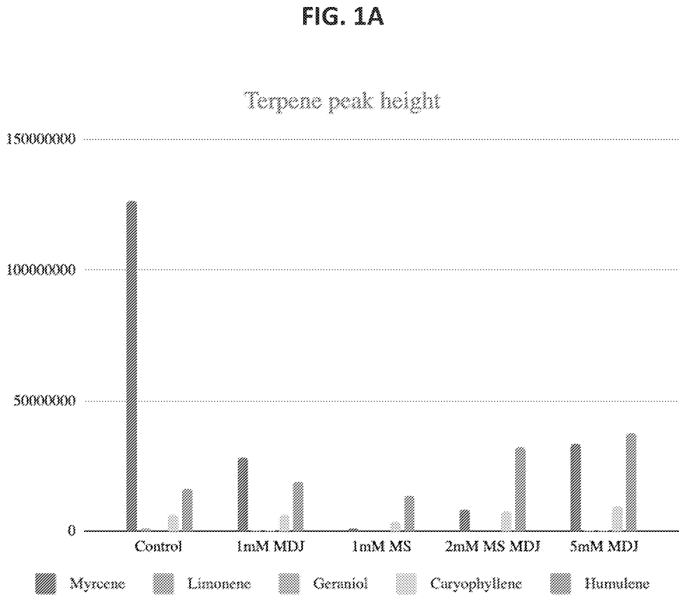

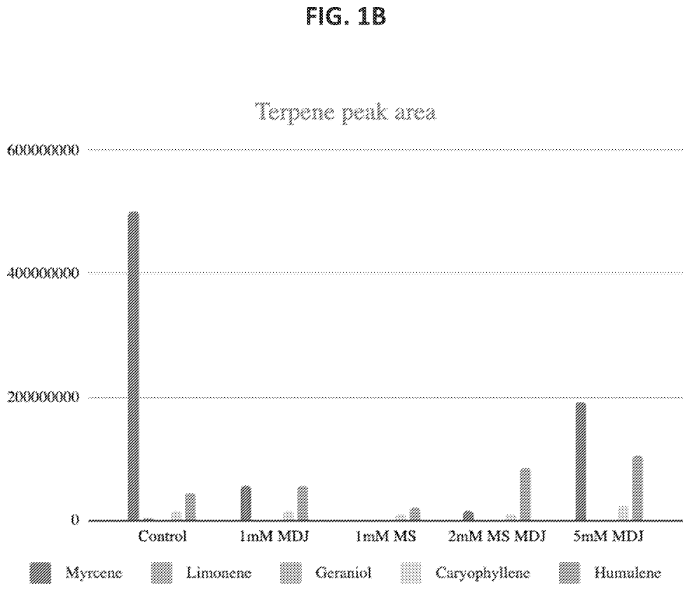

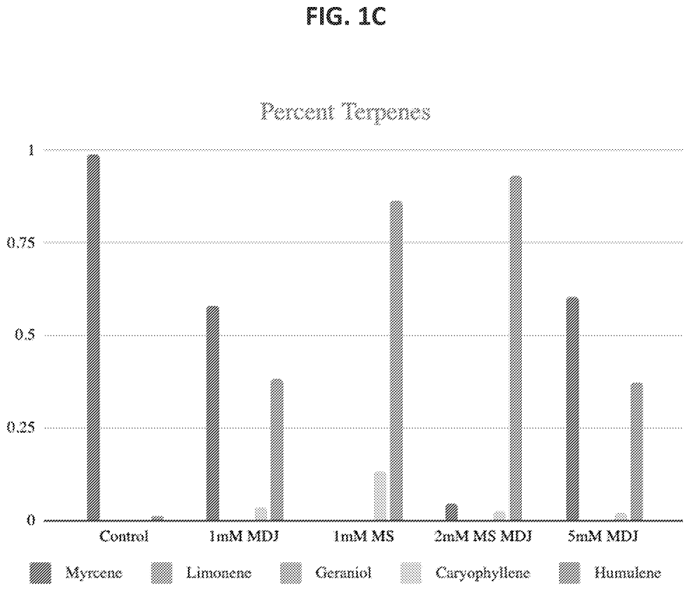

Results of the terpene analysis are shown in FIG. 1A-1C, which show results for terpene peak height, terpene peak area, and percent of total terpenes calculated from the terpene FID chromatogram. As shown in the figures, all treatment conditions altered terpene content in the hop plants compared to control.

### Example 2: Application of MDJ Alters Hop Oil Content and Secondary Metabolite Production

### Materials and Methods

Hop plants were treated with illustrative elicitor compositions of the disclosure to determine the effect of treatment on hop terpene content. The hop cultivar was Cashmere Hops. The treatments were as follows: Control (“CK2”)—Untreated control; TR1—1 mM MDJ Foliar Spray: TR2—5 mM MDJ Foliar Spray.

Harvested hops were analyzed for total oil, beta acid, alpha acid, terpene, and thiol content. Total oil analysis was performed according to Analytica EBC Method 7.10, employing steam distillation. Alpha/beta/iso-alpha acid analysis was performed using HPLC, employing a modified version of Analytica EBC Method 7.8. Terpene analysis was performed according to Analytica EBC Method 7.12, employing Capillary Gas Chromatography Flame Ionization Detection. Thiol composition was analyzed via gas chromatography with sulfur chemiluminescence detector (GC-SCD).

### Results of Analysis of General Hop Characteristics

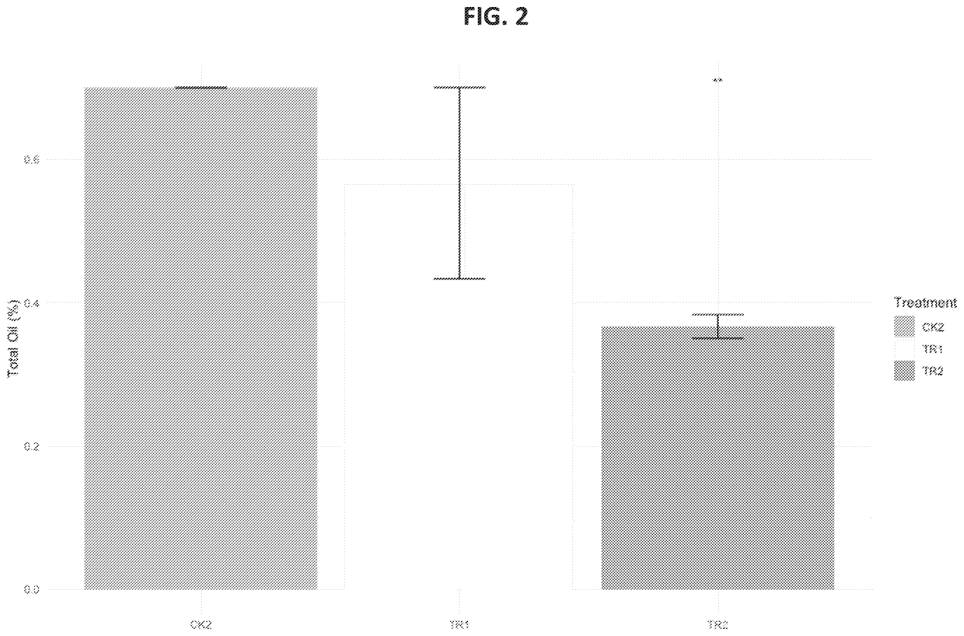

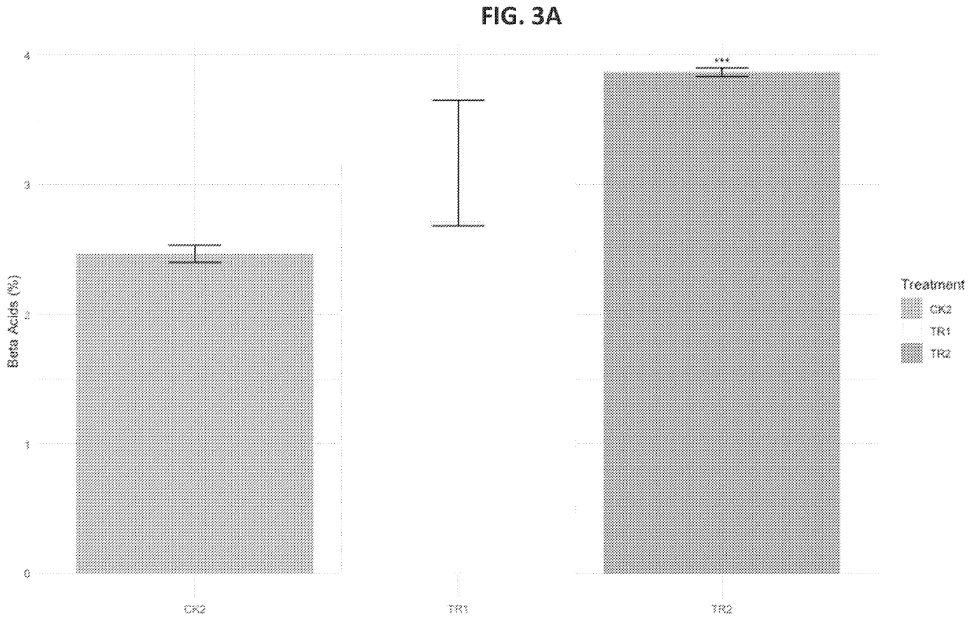

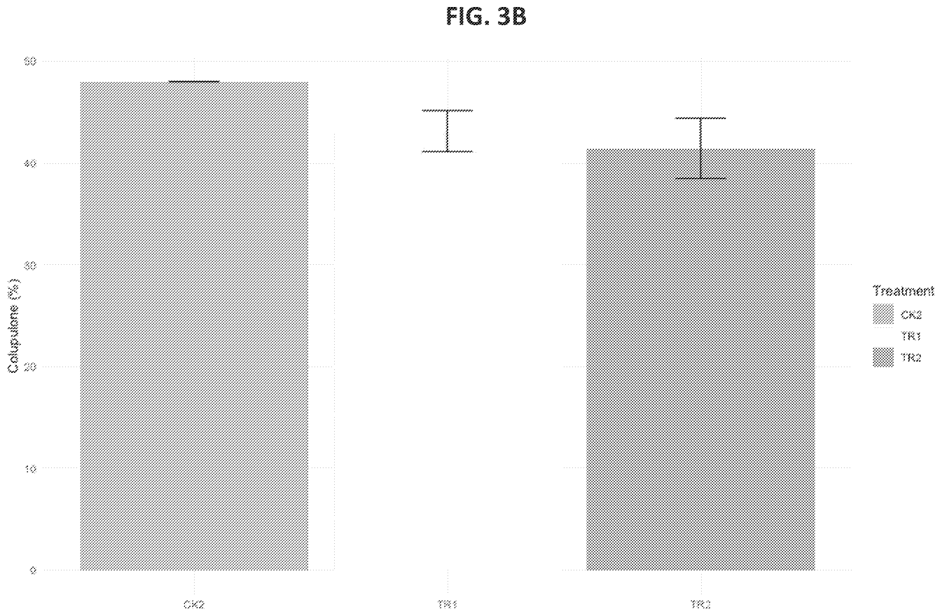

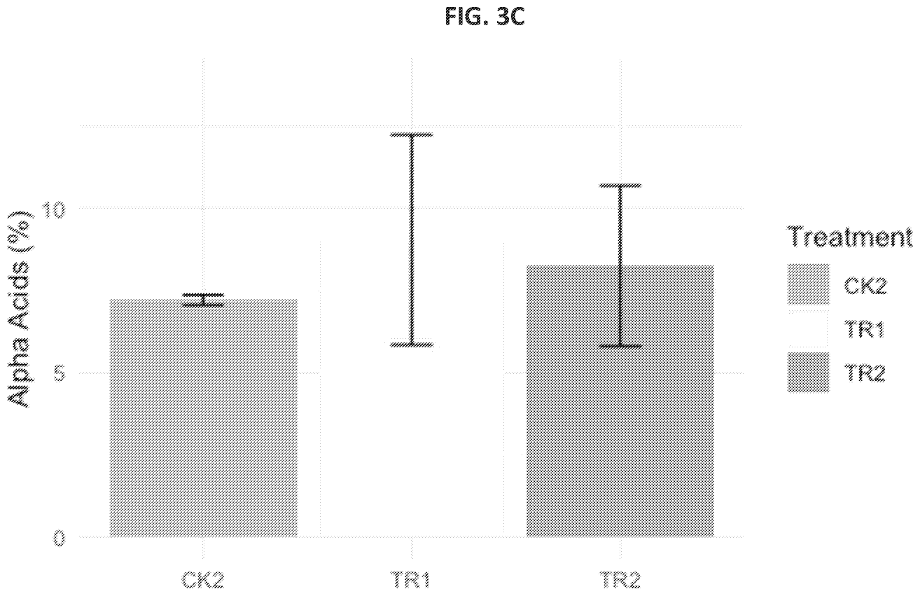

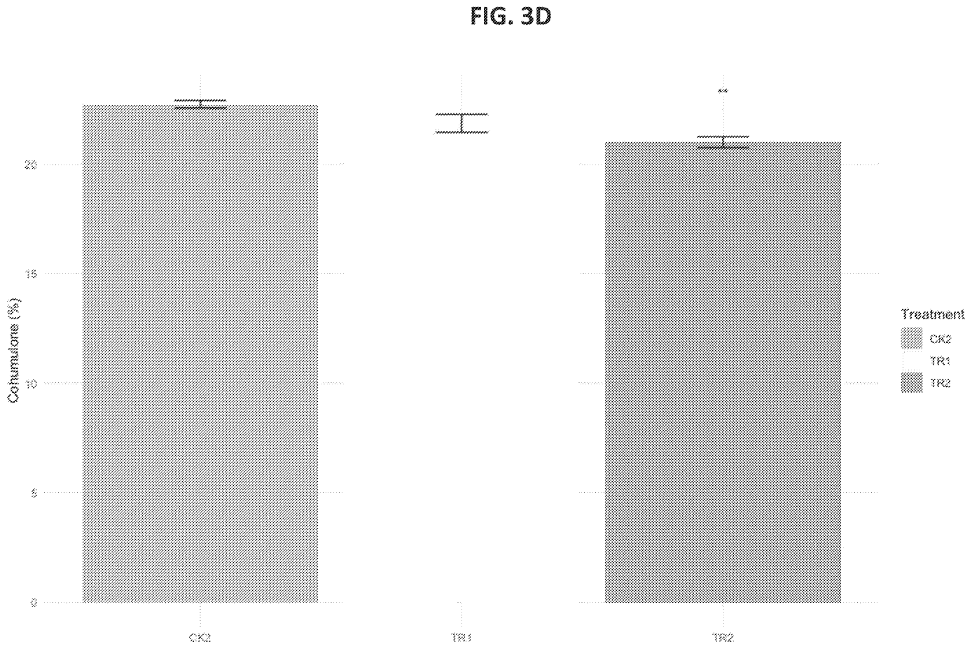

Results for total oil analysis are shown in FIG. 2. Bitter acid analysis results are shown in FIG. 3A-3D, showing a statistically significant increase in beta acid content with MDJ treatment, especially at 5 mM MDJ treatment, while the content of the alpha acid analogue cohumulone was decreased with MDJ treatment.

### Terpene Analysis Results

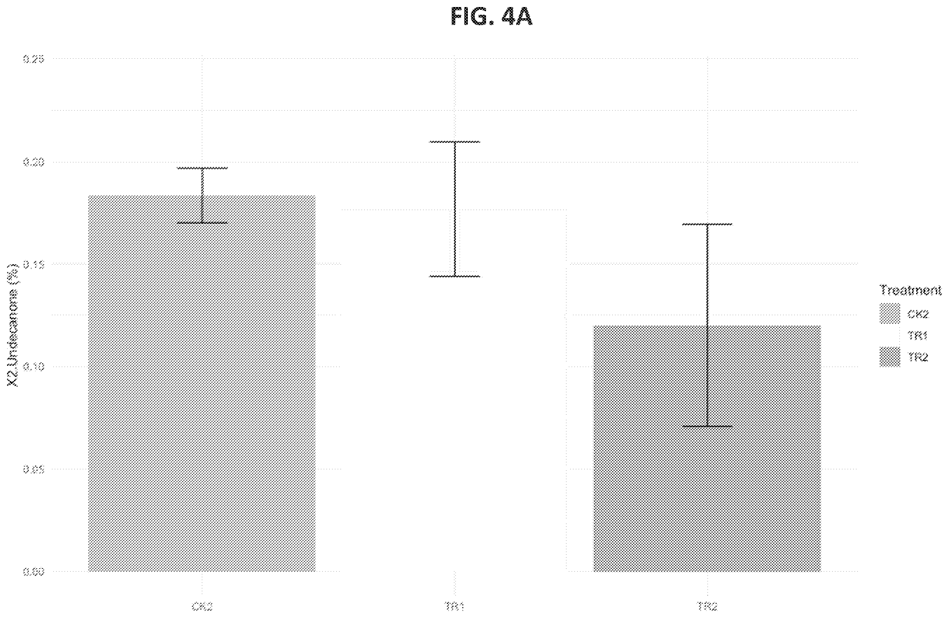

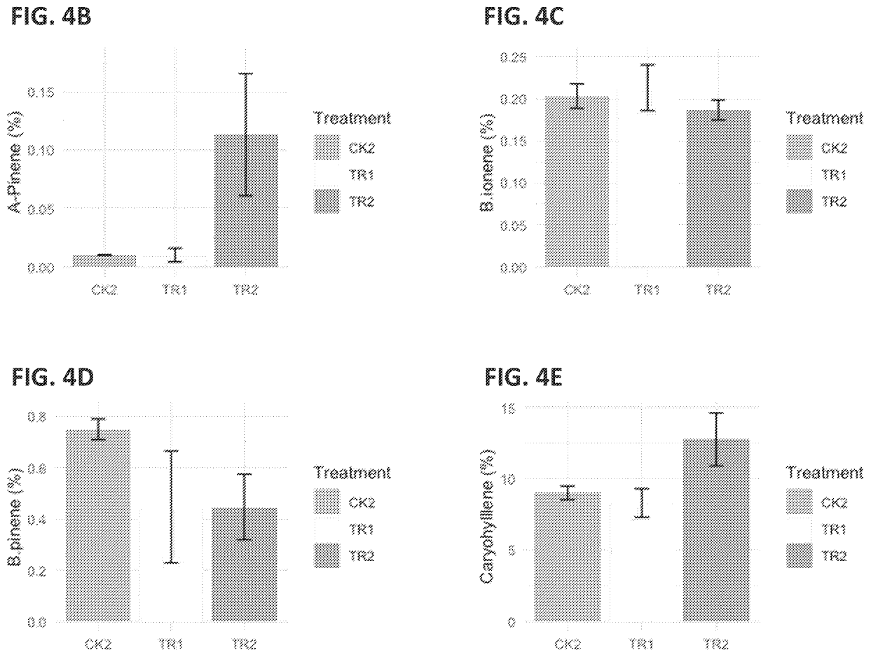

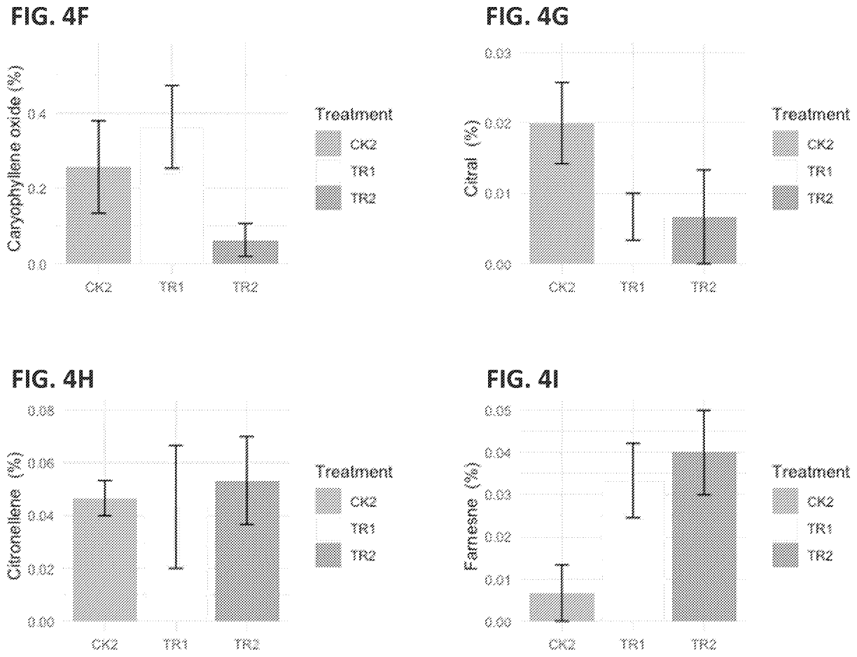

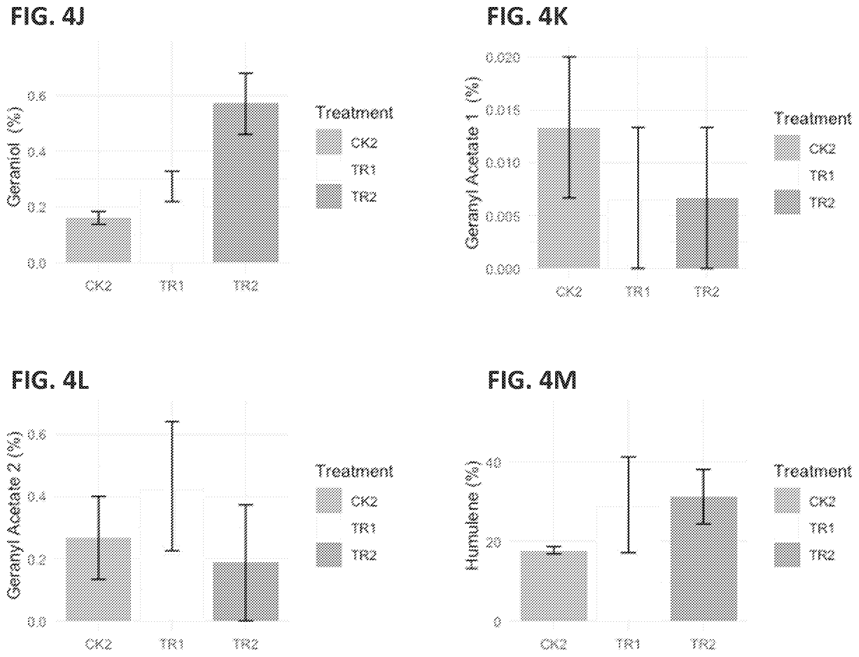

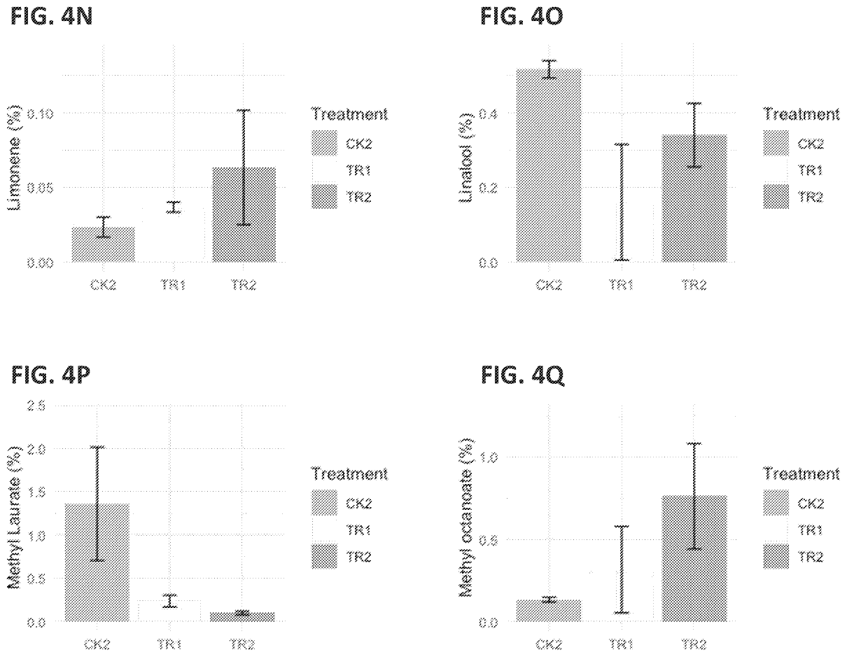

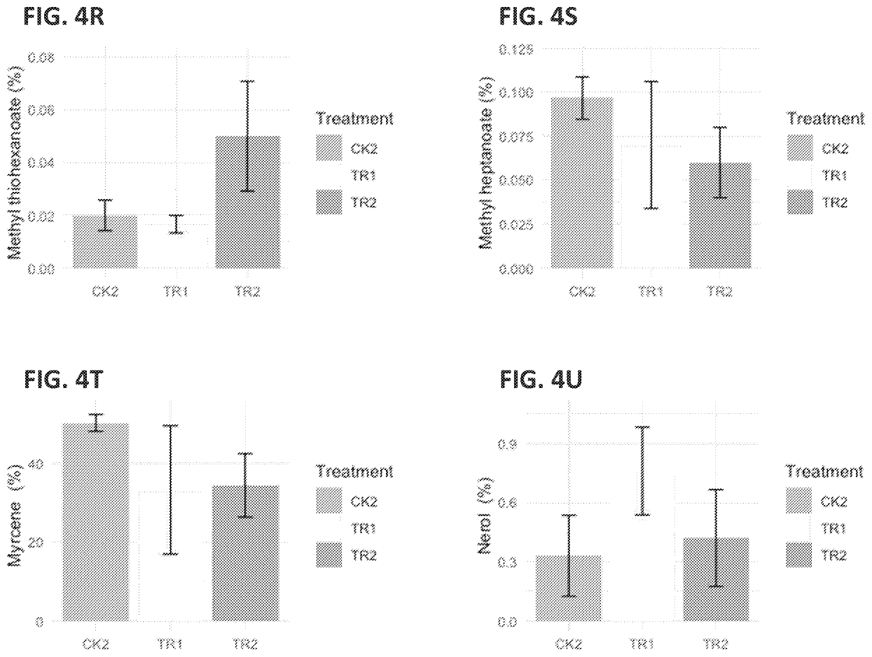

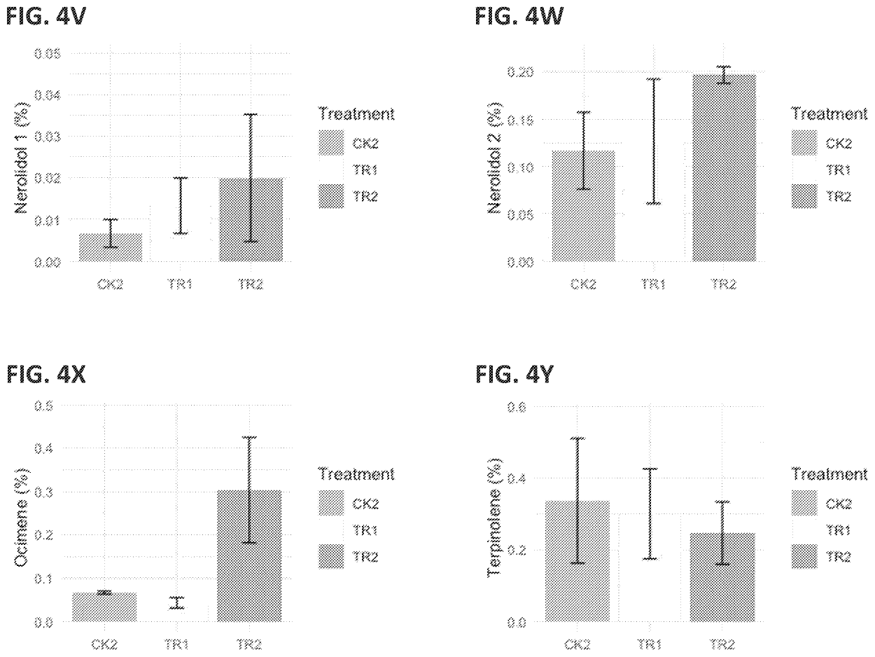

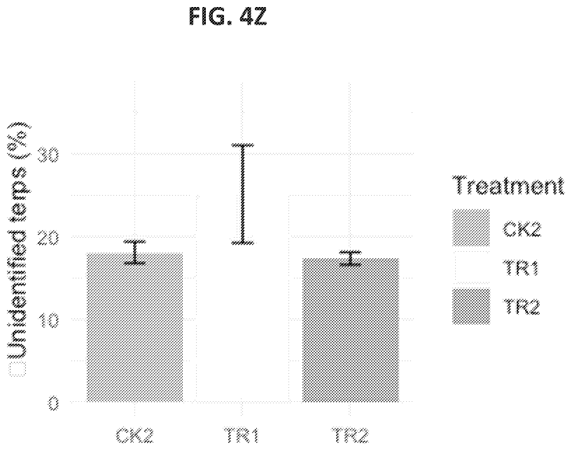

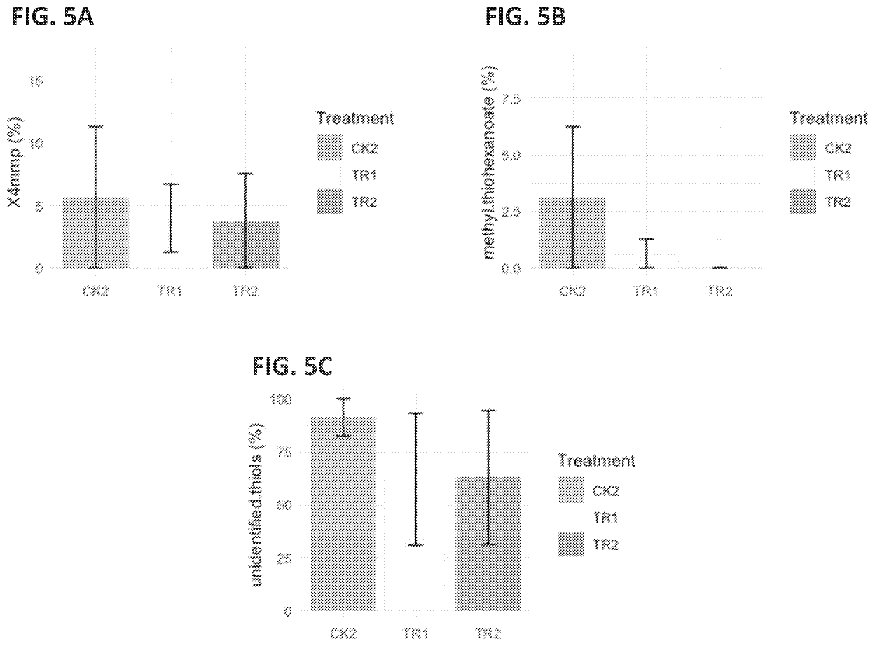

Results for terpene analysis are shown in FIG. 4A-4Z. In this illustrative analysis, the content of the following terpenes increased with 5 mM MDJ treatment: q-pinene, caryophyllene, farnesene, geraniol, humulene, methyl octanoate, methyl thiohexanoate, nerolidol, and ocimene. In this analysis, the following terpenes decreased with 5 mM MDJ treatment: β-pinene, caryophyllene oxide, citral, methyl laurate, methyl heptanoate, and myrcene.

### Thiol Analysis Results

The following thiols were analyzed in the hop plant: dimethyl sulfide/2-mercaptoethanol; 4-MMP; dimethyl trisulfide; 3-mercapto-3-methylbutanol; methyl thiohexanoate; 3-mercaptohexan-1-ol (3MH); 3-mercapto-4-methylpentylacetate/3-mercaptohexyl acetate (3MHA); and unidentified thiols. Measurements were given as percentage of overall thiols. Results for 4-MMP, methyl thiohexanoate, and unidentified thiols are shown in FIG. 5A-5C, respectively. Dimethyl sulfide, dimethyl trisulfide, 3-mercapto-3-methylbutanol, 3MH, and 3MHA were not detected in any of the samples.

### Example 3: Synergistic Control of Pests and Pathogens with MDJ and a Biological

In this illustrative example, application of a biological in conjunction with MIDJ treatment was shown to further decrease the prevalence of disease in a plant of the same Cannabaceae Family, Cannabis spp.

A Botrytis cinerea isolate was cultured onto potato-dextrose agar (PDA) and re-isolated by taking a mycelial plug from the edge of actively growing cultures every 2-3 weeks to maintain active growing culture. It was maintained at 20° C. under continuous light (~58 pEin m⁻² s⁻¹). An inoculum was prepared by flooding a full grown B. cinerea PDA plate with DI water and 0.1% Tween-20 to create a suspension of fungal spores. Spore count was quantified.

In the first inoculation, a suspension of 1.2×10⁴ spores of B. cinerea/mL was created, and 1.5 mL was applied to the top cola/underdeveloped inflorescence of each hemp plant in the first week of flowering. In the second inoculation, a suspension of 1.5×10⁵ spores of B. cinerea/mL was created, and sucrose was added to 1% concentration, and the plants were sprayed until drip using a backpack sprayer.

Inoculated plants were placed in a controlled growth environment with a constant temperature of 20-25° C. and 50-70% relative humidity. (See Zhang et al., “Infection Assays of Tomato and Apple Fruit by the Fungal Pathogen Botrytis cinerea,” bio-protocol 2014; 4 (23): 1-4. See also, Bulger et al. Phytopathology 1987; 77 (8): 1225-1230 and Garfinkel, Plant Disease 2020; 104 (7): 2026.)

Treatments comprising 1 mM or 5 mM jasmonate (MDJ) were applied alone or alongside a biological (Continuum™). These treatment conditions were compared to control (no MDJ, no biological). Each treatment group had 8 replicates. 500 mL of each treatment solution was prepared for application as a foliar spray. Plants within a treatment condition were sprayed with the corresponding treatment until drip with a hand sprayer. Approximately 400 mL of each treatment were applied per application per plant. Treatments were applied to inflorescences. Table 3 provides the labels and descriptions for each of the treatment conditions.

TABLE 3
Treatment Conditions

| Label | Description |
|---|---|
| A | Control, 0.1% tween/span mixture |
| B | 1 mM MDJ |
| C | 5 mM MDJ |
| D | Continuum ™ only (30 mL per gallon) |
| E | 1 mM MDJ + 30 mL/gallon Continuum ™ |
| F | 5 mM MDJ + 30 mL/gallon Continuum ™ |

The treatments were applied in the first week of flowering, followed 24 hours later by an inoculation of Botrytis cinerea, and then the treatments were applied again four weeks later, followed 24 hours later by another inoculation. Table 4 contains the dates of treatment, inoculation, and harvest.

TABLE 4
Treatment, Infection, and Harvest Dates

| Date | Event |
|---|---|
| May 31, 2022 | First Treatment spray (A-F) |
| Jun. 2, 2022 | First Infection |
| Jun. 28, 2022 | Second Treatment Spray (A-F) |
| Jun. 29, 2022 | Second Infection, with 1% sugar solution |
| Jul. 11, 2022 (week of) | Harvest |

Botrytis cinerea disease scoring was based on visual inspection of infection amounts. 0: No part of the plant affected; 1: minimal infection, isolated in 1 or 2 areas; 2: mild infection, multiple infection sites, but somewhat isolated; 3: moderate infection, about half of the plant is infected; 4: severe infection, most of the plant is infected; 5: extreme infection, entire plant is infected, with proliferating mold and/or necrotic symptoms occurring.

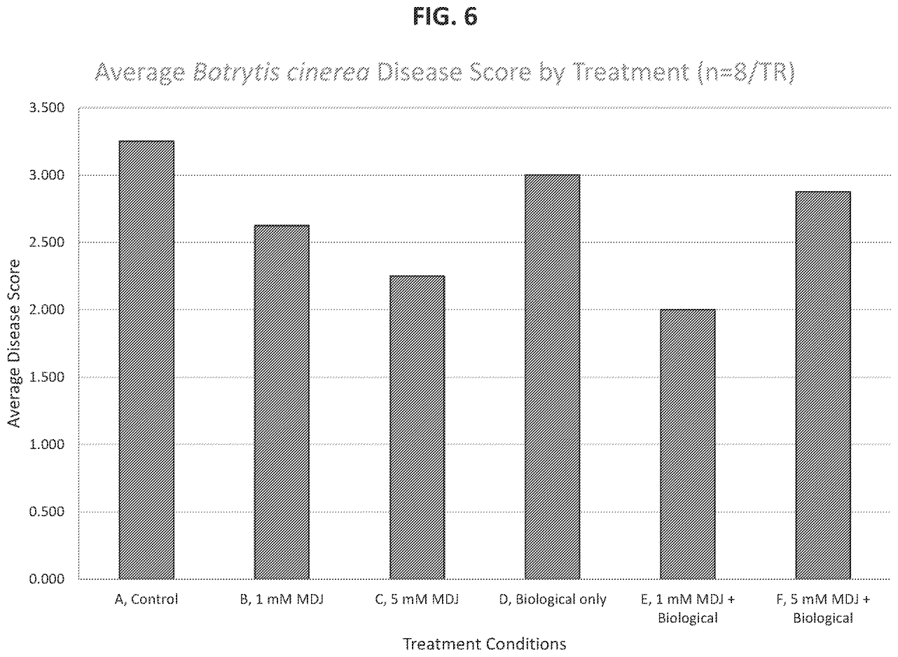

At harvest, the plants in all treatment conditions were evaluated based on their Botrytis disease score (0-5). Table 5 and FIG. 6 show a summary of the average results from each treatment condition. Surprisingly, condition E, with 1 mM MDJ and 30 mL/gallon Continuum™ outperformed all other conditions in terms of reducing disease incidence and/or progression caused by Botrytis cinerea infection. These results suggest a synergistic effect, because the disease score for condition E compared to control is improved more than the sum of the effects of either agent alone (condition B or condition D).

TABLE 5
Average Disease Scores per Treatment Condition

| Treatment | Average Disease Score |
|---|---|
| A, Control | 3.250 |
| B, 1 mM MDJ | 2.625 |
| C, 5 mM MDJ | 2.250 |
| D, Biological only | 3.000 |
| E, 1 mM MDJ + Biological | 2.000 |
| F, 5 mM MDJ + Biological | 2.875 |

### Example 4: Application of MDJ has Dose Dependent Effects on Hop Oil Content and Secondary Metabolite Production

### Materials and Methods

Hop plants were treated with illustrative elicitor compositions of the disclosure to determine the effect of treatment on hop bitter acid and terpene content. The hop cultivar was CTZ, also known as Columbus, Tomahawk, or Zeus, three trade names owned by various private corporations for the same variety of hop. The treatments were as follows: 1 mM, 5 mM, and 10 mM MDJ Foliar Spray.

Harvested hops were analyzed for total oil, beta acid, alpha acid, and terpene content. Total oil and terpene analysis was performed according to a modified version of Analytica EBC Method 7.12, employing Capillary Gas Chromatography Flame Ionization Detection. Plants were measured in triplicate from each treatment group; results represent the average of three samples. Alpha/beta/iso-alpha acid analysis was performed using HPLC, employing a modified version of Analytica EBC Method 7.8.

### Results of Analysis of General Hop Characteristics

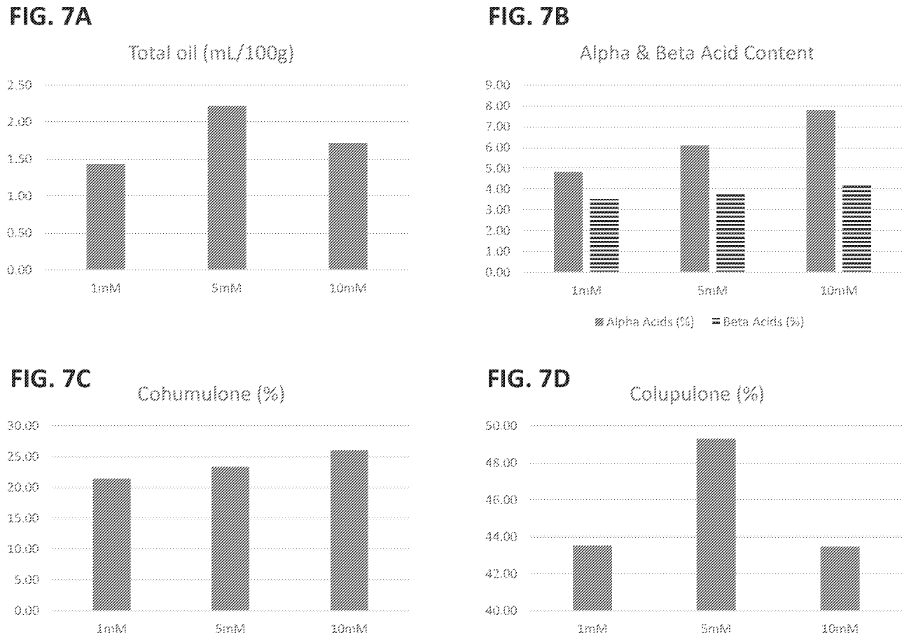

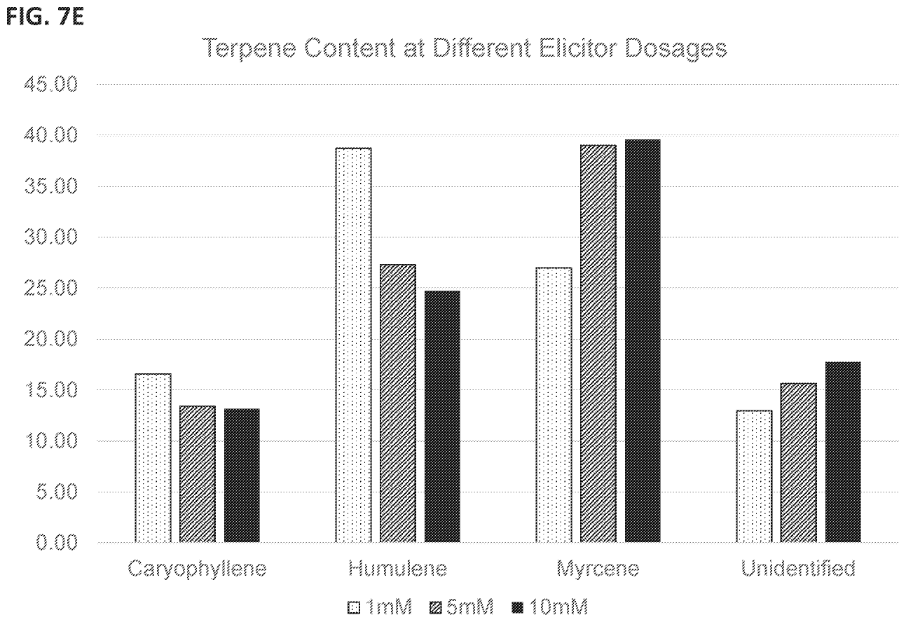

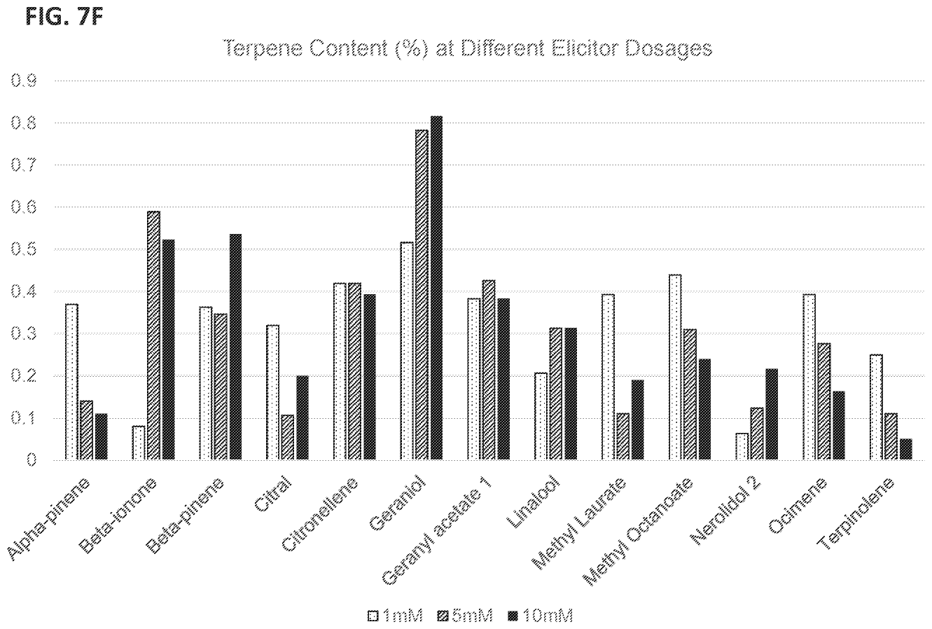

Results for total oil analysis are shown in FIG. 7A. Overall bitter acid analysis results are shown in FIG. 7B, showing a dose-dependent increase in both alpha and beta acid content with MDJ treatment. Cohumulone content (FIG. 7C) increased as a percentage of overall alpha acids with increasing MDJ concentration. Colupolone content (FIG. 7D), as a percentage of overall beta acids, was highest at 5 mM treatment. Results of total oil and bitter acids analyses are also shown in Table 6.

TABLE 6
Total oil and bitter acid content of treated hop plants.

| | | Alpha | Beta | | |
|---|---|---|---|---|---|
| | Total oil | Acids | Acids | Cohumulone | Colupulone |
| Dosage | (mL/100 g) | (%) | (%) | (% alpha) | (% beta) |
| 1 mM | 1.43 | 4.83 | 3.53 | 21.43 | 43.53 |
| 5 mM | 2.22 | 6.10 | 3.83 | 23.37 | 49.3 |
| 10 mM | 1.72 | 7.80 | 4.23 | 26.03 | 43.47 |

### Terpene Analysis Results

Results for terpene analysis are shown in FIG. 7E and FIG. 7F as a percentage of overall terpene content. Results are also shown in Tables 7A-7B.

TABLE 7A
Terpene content (%) of treated hop plants.

| | | | | | | | Caryophyl- | | | | | | Geranyl | Geranyl |
|---|---|---|---|---|---|---|---|---|---|---|---|---|---|---|
| | | 2-Undeca- | Alpha- | Beta- | Beta- | Caryophyl- | lene | | Citronel- | Citro- | | | acetate | acetate |
| Dosage | | none | pinene | ionone | pinene | lene | oxide | Citral | lene | nellol | Farnesene | Geraniol | 1* | 2** |
| 1 | mM | 0.00 | 0.37 | 0.08 | 0.36 | 16.6 | 0.12 | 0.32 | 0.42 | 0.00 | 0.00 | 0.52 | 0.38 | 0.07 |
| 5 | mM | 0.01 | 0.14 | 0.59 | 0.35 | 13.4 | 0.04 | 0.11 | 0.42 | 0.00 | 0.03 | 0.78 | 0.43 | 0.11 |
| 10 | mM | 0.07 | 0.11 | 0.52 | 0.54 | 13.2 | 0.07 | 0.20 | 0.39 | 0.00 | 0.02 | 0.82 | 0.38 | 0.09 |

*[(2E)-3,7-dimethylocta-2,6-dienyl] acetate
**[(2Z)-3,7-dimethylocta-2,6-dienyl] acetate

TABLE 7B
Terpene content (%) of treated hop plants.

| | | | | | Methyl | | Methyl | Methyl | | | Nero- | Nero- | | | |
|---|---|---|---|---|---|---|---|---|---|---|---|---|---|---|---|
| | | | | | Hepta- | Methyl | Octa- | thiohexa- | | | lidol | lidol | | Terpi- | Uniden- |
| Dosage | | Humulene | Limonene | Linalool | noate | Laurate | noate | noate | Myrcene | Nerol | 1* | 2** | Ocimene | nolene | tified |
| 1 | mM | 38.7 | 0.10 | 0.21 | 0.06 | 0.39 | 0.44 | 0.05 | 27.0 | 0.03 | 0.09 | 0.06 | 0.39 | 0.25 | 13.0 |
| 5 | mM | 27.3 | 0.09 | 0.31 | 0.05 | 0.11 | 0.31 | 0.05 | 39.0 | 0.00 | 0.14 | 0.12 | 0.28 | 0.11 | 15.7 |
| 10 | mM | 24.7 | 0.09 | 0.31 | 0.06 | 0.19 | 0.24 | 0.02 | 39.6 | 0.02 | 0.17 | 0.22 | 0.16 | 0.05 | 17.8 |

*(E)3,7,11-trimethyldodeca-1,6,10-trien-3-ol
**(Z)3,7,11-trimethyldodeca-1,6,10-trien-3-ol

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world. The entire contents of International Application No. PCT/US2022/081326 and International Publication No. WO 2022/026613 are herein incorporated by reference in their entireties for all purposes.

### Numbered Embodiments of the Invention

Notwithstanding the appended claims, the disclosure sets forth the following numbered embodiments:
1. A method for altering the production of one or more metabolites in a hop plant, plant part, or plant cell comprising: applying an effective amount of at least one elicitor, wherein the at least one elicitor is a jasmonate selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.
2. The method of embodiment 1, wherein the method comprises applying an effective amount of two jasmonates.
3. The method of embodiment 1, wherein the method comprises applying an effective amount of three jasmonates.
4. The method of embodiment 1, wherein the jasmonate is methyl jasmonate.
5. The method of embodiment 1, wherein the jasmonate is methyl dihydrojasmonate.
6. The method of embodiment 1, wherein the jasmonate is cis-jasmone.
7 The method of embodiment 2, wherein the two jasmonates are methyl jasmonate and methyl dihydrojasmonate.
8 The method of embodiment 2, wherein the two jasmonates are methyl jasmonate and cis-jasmone.
9 The method of embodiment 2, wherein the two jasmonates are methyl dihydrojasmonate and cis-jasmone.
10. The method of embodiment 3, wherein the three jasmonates are methyl jasmonate, methyl dihydrojasmonate, and cis-jasmone.
11. The method of any one of embodiments 1-10, wherein the method further comprises applying an effective amount of a non-jasmonate elicitor and/or a plant growth regulator.
12. The method of embodiment 11, wherein the non-jasmonate elicitor is a salicylate.
13. The method of embodiment 12, wherein the salicylate is methyl salicylate and/or salicylic acid.
14. The method of embodiment 11, wherein the plant growth regulator is an ethylene inhibitor.
15. The method of embodiment 14, wherein the ethylene inhibitor is 1-methylcyclopropene.
16. The method of any one of embodiments 1-15, wherein the elicitor is applied as a foliar spray or root drench
17. The method of any one of embodiments 1-16, wherein the elicitor is applied at emergence.
18. The method of any one of embodiments 1-16, wherein the elicitor is applied during vegetative growth.
19. The method of any one of embodiments 1-16, wherein the elicitor is applied before flowering.
20. The method of any one of embodiments 1-16, wherein the elicitor is applied during or after flowering.
21 The method of any one of embodiments 1-16, wherein the elicitor is applied before cone formation.
22. The method of any one of embodiments 1-16, wherein the elicitor is applied directly to cones.
23. The method of any one of embodiments 1-16, wherein the elicitor is applied before harvest.
24. The method of any one of embodiments 1-23, wherein the step of applying the elicitor is repeated one or more times, thereby carrying out a plurality of applications.
25. The method of embodiment 24, wherein each application is separated by between 5-20 day.
26. The method of embodiments 24, wherein at least two applications are separated by at least 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.
27. The method of embodiment 24, wherein at least two applications are separated by between 5-20 days.
28. The method of any one of embodiments 1-27, wherein the effective amount of the jasmonate is between 10 mL to 1 L of a composition comprising between 0.1 mM and 10 mM of the jasmonate.
29 The method of embodiment 28, wherein the composition comprises between 1 mM and 5 mM of the jasmonate.
30. The method of any one of embodiments 1-27, wherein the effective amount is between 350-850 ppm with an application rate of 50 gallons per acre.
31. The method of any one of embodiments 1-27, wherein the effective amount is between 850-1700 ppm with an application rate of 100 gallons per acre.
32. The method of any one of embodiments 1-31, wherein the metabolite is a bitter acid, terpene, polyphenol, or thiol.
33. The method of embodiment 32, wherein the bitter acid is a beta acid.
33.1 The method of embodiment 32, wherein the bitter acid is an alpha acid.
34. The method of embodiment 32, wherein the terpene is α-pinene, caryophyllene, farnesene, geraniol, humulene, methyl octanoate, methyl thiohexanoate, nerolidol, or ocimene.
35. A method of altering metabolite levels in a hop plant or plant part, said method comprising: applying an effective amount of methyl dihydrojasmonate to a hop plant or plant part.
36 The method of embodiment 35, wherein the metabolite is increased compared to an untreated hop plant or plant part.
37. The method of embodiment 35, wherein the metabolite is decreased compared to an untreated hop plant or plant part.
38. The method of any one of embodiments 35-37, wherein the effective amount of methyl dihydrojasmonate is a composition having between 0.1 mM and 10 mM methyl dihydrojasmonate applied at a rate of 10-150 gallons per acre.
39. The method of embodiment 38, wherein the composition comprises about 1 mM methyl dihydrojasmonate.
40 The method of embodiment 38, wherein the composition comprises about 2.5 mM methyl dihydrojasmonate.
41. The method of embodiment 38, wherein the composition comprises about 5 mM methyl dihydrojasmonate.
42. The method of embodiment 38, wherein the composition comprises about 7.5 mM methyl dihydrojasmonate.
43. The method of embodiment 38, wherein the composition comprises about 10 mM methyl dihydrojasmonate.
44. The method of any one of embodiments 38-43, wherein the composition comprises an adjuvant.
45. The method of embodiment 44, wherein the adjuvant is a surfactant.
46. The method of embodiment 45, wherein the surfactant is polysorbate-20.
47. The method of any one of embodiments 38-46, wherein the composition comprises at least one of an additional elicitor, fungicide, pesticide, and plant beneficial nutrient.
48. The method of embodiment 47, wherein the additional elicitor an ethylene inhibitor.
49. The method of embodiment 48, wherein the ethylene inhibitor is 1-methylcyclopropene.
50. The method of any one of embodiments 38-49, wherein the composition is applied two or more times, thereby carrying out a plurality of composition applications.
51. The method of embodiment 50, wherein each composition application is separated by at least 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.
52. The method of embodiment 50, wherein each composition application is separated by between 5-20 days.
53. The method of embodiment 50, wherein at least two composition applications are separated by about 7 or about 14 days.
54. The method of any one of embodiments 35-53, wherein a salicylate is also applied to the hop plant or plant part.
55. The method of embodiment 54, wherein the salicylate is methyl salicylate and/or salicylic acid.
56. The method of embodiment 55, wherein the salicylate is applied at a concentration of between 0.1 mM and 10 mM.
57. The method of any one of embodiments 54-56, wherein the salicylate is applied simultaneously with the effective amount of methyl dihydrojasmonate.
58. The method of any one of embodiments 35-57, wherein the effective amount of methyl dihydrojasmonate is applied as a foliar spray or root drench.
59. The method of any one of embodiments 35-58, wherein the method reduces the content variability of a metabolite in a population of hop plants.
60. A method for increasing the content of a bitter acid in a hop plant, plant part, or plant cell, the method comprising: applying an effective amount of methyl dihydrojasmonate, wherein said effective amount is comprised of a composition having between 0.1 mM and 10 mM methyl dihydrojasmonate applied at an application rate of between 10-150 gallons per acre.
61. The method of embodiment 60, wherein the bitter acid is a beta acid.
61.1 The method of embodiment 60, wherein the bitter acid is an alpha acid.
62. The method of any one of embodiments 60-61, wherein the method also decreases the content of an alpha acid.
63. The method of embodiment 62, wherein the alpha acid is cohumulone.
64. The method of any one of embodiments 60-63, wherein the method increases the total content of all beta acids.
65. A method for increasing the content of a terpene in a Hop plant, plant part, or plant cell, the method comprising: applying an effective amount of methyl dihydrojasmonate, wherein said effective amount is comprised of a composition having between 0.1 mM and 10 mM methyl dihydrojasmonate applied at an application rate of between 10-150 gallons per acre.
66. The method of embodiment 65, wherein the terpene is β-pinene, caryophyllene oxide, citral, methyl laurate, methyl heptanoate, or myrcene.
67. A composition comprising methyl dihydrojasmonate and a plant cell from a hop plant.
68. A method of reducing, treating, and/or preventing pest or pathogen damage to a hop plant, plant part, or plant cell, the method comprising: applying to the hop plant, plant part, or plant cell an effective amount of at least one elicitor, wherein the at least one elicitor is a jasmonate selected from the group consisting of methyl jasmonate, jasmonic acid, methyl dihydrojasmonate, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.
69. The method of embodiment 68, wherein the jasmonate is methyl dihydrojasmonate.
70. The method of embodiment 68 or 69, wherein the method comprises also applying a biological to the hop plant, plant part or plant cell.
71. The method of embodiment 70, wherein the biological is Continuum™.
72. The method of any one of embodiments 68-71, wherein the method decreases the disease score of plants exposed to a pest or pathogen compared to a control plant.
73. The method of any one of embodiments 69-72, wherein there is a synergistic improvement in the reduction, treatment, and/or prevention of pest and/or pathogen damage from the application of the combination of the elicitor and the biological, compared to application of either alone.

1. A method for altering the production of one or more metabolites in a hop plant, plant part, or plant cell comprising: applying an effective amount of at least one elicitor, wherein the at least one elicitor is a jasmonate selected from the group consisting of methyl dihydrojasmonate, methyl jasmonate, jasmonic acid, cis-jasmone, transjasmone, methyl (+)-7-isojasmonate, dihydrojasmonate, prohydrojasmone, isojasmone, methyl dihydro iso jasmonate, and analogues, isomers, derivatives or conjugates thereof.

2. The method of claim 1, wherein the method comprises applying an effective amount of two jasmonates.

3. The method of claim 1, wherein the method comprises applying an effective amount of three jasmonates.

4. The method of claim 1, wherein the jasmonate is methyl jasmonate.

5. The method of claim 1, wherein the jasmonate is methyl dihydrojasmonate.

6. The method of claim 1, wherein the jasmonate is cis-jasmone.

7. The method of claim 2, wherein the two jasmonates are methyl jasmonate and methyl dihydrojasmonate.

8. The method of claim 2, wherein the two jasmonates are methyl jasmonate and cis-jasmone.

9. The method of claim 2, wherein the two jasmonates are methyl dihydrojasmonate and cis-jasmone.

10. The method of claim 3, wherein the three jasmonates are methyl jasmonate, methyl dihydrojasmonate, and cis-jasmone.

11. The method of any one of claims 1-10, wherein the method further comprises applying an effective amount of a non-jasmonate elicitor and/or a plant growth regulator.

12. The method of claim 11, wherein the non-jasmonate elicitor is a salicylate.

13. The method of claim 12, wherein the salicylate is methyl salicylate and/or salicylic acid.

14. The method of claim 11, wherein the plant growth regulator is an ethylene inhibitor.

15. The method of claim 14, wherein the ethylene inhibitor is 1-methylcyclopropene.

16. The method of any one of claims 1-15, wherein the elicitor is applied as a foliar spray or root drench.

17. The method of any one of claims 1-16, wherein the elicitor is applied at emergence.

18. The method of any one of claims 1-16, wherein the elicitor is applied during vegetative growth.

19. The method of any one of claims 1-16, wherein the elicitor is applied before flowering.

20. The method of any one of claims 1-16, wherein the elicitor is applied during or after flowering.

21. The method of any one of claims 1-16, wherein the elicitor is applied before cone formation.

22. The method of any one of claims 1-16, wherein the elicitor is applied directly to cones.

23. The method of any one of claims 1-16, wherein the elicitor is applied before harvest.

24. The method of any one of claims 1-23, wherein the step of applying the elicitor is repeated one or more times, thereby carrying out a plurality of applications.

25. The method of claim 23, wherein each application is separated by between 5-20 day.

26. The method of claim 23, wherein at least two applications are separated by at least 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.

27. The method of claim 23, wherein at least two applications are separated by between 5-20 days.

28. The method of any one of claims 1-27, wherein the effective amount of the jasmonate is between 10 mL to 1 L of a composition comprising between 0.1 mM and 10 mM of the jasmonate.

29. The method of claim 28, wherein the composition comprises between 1 mM and 7.5 mM of the jasmonate.

30. The method of any one of claims 1-27, wherein the effective amount is between 350-850 ppm with an application rate of 50 gallons per acre.

31. The method of any one of claims 1-27, wherein the effective amount is between 850-1700 ppm with an application rate of 100 gallons per acre.

32. The method of any one of claims 1-31, wherein the metabolite is a bitter acid, terpene, polyphenol, or thiol.

33. The method of claim 32, wherein the bitter acid is a beta acid.

34. The method of claim 32, wherein the terpene is α-pinene, caryophyllene, farnesene, geraniol, humulene, methyl octanoate, methyl thiohexanoate, nerolidol, or ocimene.

35. A method of altering metabolite levels in a hop plant or plant part, said method comprising: applying an effective amount of methyl dihydrojasmonate to a hop plant or plant part.

36. The method of claim 35, wherein the metabolite is increased compared to an untreated hop plant or plant part.

37. The method of claim 35, wherein the metabolite is decreased compared to an untreated hop plant or plant part.

38. The method of any one of claims 35-37, wherein the effective amount of methyl dihydrojasmonate is a composition having between 0.1 mM and 10 mM methyl dihydrojasmonate applied at a rate of 10-150 gallons per acre.

39. The method of claim 38, wherein the composition comprises about 2.5 mM methyl dihydrojasmonate.

40. The method of claim 38, wherein the composition comprises about 5 mM methyl dihydrojasmonate.

41. The method of claim 38, wherein the composition comprises about 7.5 mM methyl dihydrojasmonate.

42. The method of any one of claims 38-41, wherein the composition comprises an adjuvant.

43. The method of claim 42, wherein the adjuvant is a surfactant.

44. The method of claim 43, wherein the surfactant is polysorbate-20.

45. The method of any one of claims 38-44, wherein the composition comprises at least one of an additional elicitor, fungicide, pesticide, and plant beneficial nutrient.

46. The method of claim 45, wherein the additional elicitor an ethylene inhibitor.

47. The method of claim 46, wherein the ethylene inhibitor is 1-methylcyclopropene.

48. The method of any one of claims 38-47, wherein the composition is applied two or more times, thereby carrying out a plurality of composition applications.

49. The method of claim 48, wherein each composition application is separated by at least 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days.

50. The method of claim 48, wherein each composition application is separated by between 5-20 days.

51. The method of claim 48, wherein at least two composition applications are separated by about 7 or about 14 days.

52. The method of any one of claims 35-51, wherein a salicylate is also applied to the hop plant or plant part.

53. The method of claim 52, wherein the salicylate is methyl salicylate and/or salicylic acid.

54. The method of claim 53, wherein the salicylate is applied at a concentration of between 0.1 mM and 10 mM.

55. The method of any one of claims 52-54, wherein the salicylate is applied simultaneously with the effective amount of methyl dihydrojasmonate.

56. The method of any one of claims 35-55, wherein the effective amount of methyl dihydrojasmonate is applied as a foliar spray or root drench.

57. The method of any one of claims 35-56, wherein the method reduces the content variability of a metabolite in a population of hop plants.

58. A method for increasing the content of a bitter acid in a hop plant, plant part, or plant cell, the method comprising: applying an effective amount of methyl dihydrojasmonate, wherein said effective amount is comprised of a composition having between 0.1 mM and 10 mM methyl dihydrojasmonate applied at an application rate of between 10-150 gallons per acre.

59. The method of claim 58, wherein the bitter acid is a beta acid.

60. The method of claim 58, wherein the method also decreases the content of an alpha acid.

61. The method of claim 60, wherein the alpha acid is cohumulone.

62. The method of claim 58, wherein the method increases the total content of all beta acids.

63. A method for increasing the content of a terpene in a hop plant, plant part, or plant cell, the method comprising: applying an effective amount of methyl dihydrojasmonate, wherein said effective amount is comprised of a composition having between 0.1 mM and 10 mM methyl dihydrojasmonate applied at an application rate of between 10-150 gallons per acre.

64. The method of claim 63, wherein the terpene is β-pinene, caryophyllene oxide, citral, methyl laurate, methyl heptanoate, or myrcene.

65. A composition comprising methyl dihydrojasmonate and a plant cell from a hop plant.
